(19) United States
(12) Patent Application Publication
(10) Pub. No.: US 2024/0098633 A1
(43) Pub. Date: Mar. 21, 2024

(54) METHODS AND APPARATUS FOR ASSISTED FREQUENCY SCAN SIGNALING

(71) Applicant: QUALCOMM Incorporated, San Diego, CA (US)

(72) Inventors: Aria Hasanzadezonuzy, Somerville, NJ (US); Navid Abedini, Basking Ridge, NJ (US); Jianghong Luo, Skillman, NJ (US); Naeem Akl, Bridgewater, NJ (US); Tao Luo, San Diego, CA (US); Junyi Li, Fairless Hills, PA (US); Wanshi Chen, San Diego, CA (US); Peter Gaal, San Diego, CA (US)

(21) Appl. No.: 17/933,732

(22) Filed: Sep. 20, 2022

(51) Int. Cl. H04W 52/02

(52) U.S. Cl. CPC H04W 52/0206

(57) ABSTRACT

Methods and apparatus for assisted frequency scan signaling are described. A method for wireless communication at a cell may comprise entering a semi-active state corresponding to an energy-saving mode of operation of the cell; configuring a downlink signal to assist at least one user equipment (UE) to detect a synchronization signal transmitted from at least one cell in an active state; and transmitting the downlink signal during the semi-active state. A method for wireless communication at a UE may comprise receiving a downlink signal from a cell in a semi-active state corresponding to an energy-saving mode of operation of the cell; detecting, based at least in part on the downlink signal, a synchronization signal transmitted from at least one cell in an active state; and establishing a connection with the at least one cell in the active state based at least in part on the synchronization signal.

### FIELD OF THE DISCLOSURE

Aspects of the present disclosure generally relate to wireless communication and to techniques, apparatus and systems for network energy/power saving. In some more specific aspects, the techniques described herein relate to assisted frequency scan signaling.

### BACKGROUND

Power is generally defined as the amount of energy transferred or converted per unit time. In the International System of Units, the unit of power is the watt (W), equal to one joule (J) per second (s). However, in the context of the present disclosure the terms power and energy may be used interchangeably.

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies comprise code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

In 5G systems, wireless devices (e.g., UEs) may have limited battery power or be subject to maximum permissible exposure (MPE) levels that may restrict transmission power levels. In addition to developing techniques for UE power saving, it may also be desirable to develop techniques and features to allow the wireless network nodes (e.g., cells) to save power (i.e., energy). This may be particularly desirable in 5G systems, where the density of the network nodes may be higher than in earlier wireless communication systems.

### SUMMARY

The invention is defined by the independent claims. Some advantageous embodiments are defined by the dependent claims or described elsewhere in the present disclosure. In general, the disclosure relates to methods, systems, devices, and apparatuses that enable power savings (i.e., energy savings) at wireless network nodes (e.g., cells). In the context of the present disclosure the terms power and energy may be used interchangeably.

A wireless network may comprise one or more base stations (also referred to herein as network access nodes, network nodes, cells, NodeBs, gNodeBs or gNBs, etc.) that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The techniques described herein add an option for a cell to enter a semi-active state, which from the perspective of energy/power consumption and/or functionality and/or latency may be considered to represent an intermediary state between an inactive state and an active state. According to various aspects of the present disclosure, a cell may be at one time in one of an inactive state, an active state, and in (at least) one semi-active state. The cell may transition between any of the states, for example, in response to an event (e.g., a condition being fulfilled, a trigger signal, a timer, etc.).

The inactive state may correspond to a state with low energy/power consumption and/or limited functionality, for example, a state in which the cell may respond only to a trigger signal instructing the cell to switch into a state with higher energy/power consumption and/or more functionality. In some aspects, the energy/power consumption in the inactive state may be below a first energy/power threshold, P_{TH1}. Therefore, the inactive state may be considered an energy-saving mode of operation. One drawback associated with a cell in the inactive state may be the latency of the cell for responding to trigger signals, which may be the highest among all energy/power states of the cell.

The semi-active state may also correspond to an energy-saving mode of operation, in which the energy/power consumption at the cell may only be slightly higher than in the inactive state (e.g., at its peak and/or on the average). In some aspects, the energy/power consumption of a cell in the semi-active state may be above the first energy/power threshold, P_{TH1}, but below a second energy/power threshold, P_{TH2}. During the at least one semi-active state, the cell is capable of a reduced mode of operation, in particular, it may send and/or receive a reduced number of signals. For example, a cell in a semi-active state may send a downlink signal, which may be periodical, and which may be conveniently referred to as an assisted frequency scan (AFS) signal. The AFS signal may be configured to assist at least one UE receiving the signal to find (i.e., detect) at least one cell in an active state. The latency of a cell in the semi-active state may be lower than the latency of the cell in the inactive state. In some aspects, there may be multiple semi-active states, each one characterized by different energy/power thresholds, functionality, and latencies.

The active state may correspond to an energy-intensive mode of operation of the cell, i.e., a mode of operation in which the energy/power consumption of the cell may be the highest (e.g., at its peak and/or on the average) among all the states. In particular, the energy/power consumption during the active state may be higher than the energy/power consumption during the at least one semi-active state, for example, it may be higher than the second energy/power threshold, P_{TH2}, defining the upper limit of the energy/power consumption for the one (or more) semi-active state(s). In some aspects, a cell in the active state may transmit with higher than nominal power in order to compensate for coverage gaps of neighboring cells in inactive or semi-active states corresponding to one or more energy-saving modes of operation of the respective cells. During the active state the cell is fully operational, and its latency may be the lowest among all the states. In some aspects, the latency of the cell in a state may be inversely proportional with its power consumption.

A cell in the active state may also be referred to as an active cell, a cell in the (at least one) semi-active state may also be referred to as a semi-active cell, and a cell in the inactive state may also be referred to as an inactive cell. In some aspects, the cell(s) in the semi-active state(s) and the cell(s) in the active state may belong to the same base station or to different base stations. Alternatively, a cell may be identified as a base station. The term cell is used interchangeably to refer to a base station, a subcomponent of a base station, or the coverage area of a base station. A base station may also be denoted as gNB or gNodeB.

A method of wireless communication by a cell is described. The method comprises: entering a semi-active state corresponding to an energy-saving mode of operation; configuring a downlink signal to assist at least one user equipment (UE) to detect a synchronization signal transmitted from at least one cell in an active state; and transmitting the downlink signal during the semi-active state.

Another method for wireless communication by a user equipment (UE) is described. The method comprises: receiving a downlink signal from a cell in a semi-active state corresponding to an energy-saving mode of operation of the cell; detecting, based at least in part on the downlink signal, a synchronization signal transmitted from at least one cell in an active state; and establishing a connection with the at least one cell in the active state based at least in part on the synchronization signal.

An apparatus for wireless communication by a cell is described. The apparatus comprises a processor, memory coupled with the processor, and instructions stored in the memory. The instructions are executable by the processor to cause the apparatus to enter a semi-active state corresponding to an energy saving mode of operation, configure a downlink signal to assist at least one user equipment (UE) to detect a synchronization signal transmitted from at least one cell in an active state, and transmit the downlink signal during the semi-active state.

Another apparatus for wireless communication by a cell is described. The apparatus comprises: means for entering a semi-active state corresponding to an energy-saving mode of operation of the cell; means for configuring a downlink signal to assist at least one user equipment (UE) to detect a synchronization signal transmitted from at least one cell in an active state; and means for transmitting the downlink signal during the semi-active state.

An apparatus for wireless communication by a user equipment (UE) is described. The apparatus comprises: a processor, a memory coupled to the processor and instructions stored in the memory and executable by the processor to cause the apparatus to: receive a downlink signal from a cell in a semi-active state corresponding to an energy-saving mode of operation of the cell, detect, based at least in part on the downlink signal, a synchronization signal transmitted from at least one cell in an active state; and establish a connection with the at least one cell in the active state based at least in part on the synchronization signal.

Another apparatus for wireless communication by a user equipment (UE) is described. The apparatus comprises: means for receiving a downlink signal from a cell in a semi-active state corresponding to an energy saving mode of operation of the cell; means for detecting, based at least in part on the downlink signal, a synchronization signal transmitted from at least one cell in an active state; and means for establishing a connection with the at least one cell in the active state based at least in part on the synchronization signal.

A non-transitory computer-readable medium storing a plurality of processor executable instructions (i.e., also known as computer- or processor-executable code, or program code) is described. Executing the processor-executable instructions causes one or more processors associated with a cell to: enter a semi-active state corresponding to an energy-saving mode of operation of the cell; configure a downlink signal to assist at least one user equipment (UE) to detect a synchronization signal transmitted from at least one cell in an active state; and transmit the downlink signal during the semi-active state.

Another non-transitory computer-readable medium storing a plurality of processor-executable instructions (i.e., also known as computer- or processor-executable code, or program code) is described. Executing the processor-executable instructions causes one or more processor associated with a user equipment (UE) to: receive a downlink signal from a cell in a semi-active state corresponding to an energy-saving mode of operation of the cell; detect, based at least in part on the downlink signal, a synchronization signal transmitted from at least one cell in an active state; and establish a connection with the at least one cell in the active state based at least in part on the synchronization signal.

A method for wireless communication by at least one first cell and at least one second cell is described. The method comprises: entering, at the at least one first cell and at the at least one second cell, a semi-active state corresponding to an energy-saving mode of operation of the at least one first cell and the at least one second cell; configuring, at the at least one first cell at least one first downlink signal, and at the at least one second cell at least one second downlink signal, to assist at least one user equipment (UE) to detect on at least one frequency channel a synchronization signal transmitted from at least one cell in an active state; wherein the at least one first downlink signal is configured to indicate that the at least one frequency channel is within a pre-configured range on a frequency raster, and wherein the at least one second downlink signal is configured to indicate that the at least one frequency channel is not within a pre-configured range on a frequency raster; and transmitting the at least one first downlink signal from the at least first cell, and the at least one second downlink signal from the at least one second cell, during the semi-active state corresponding to an energy-saving mode of operation of the at least one first cell and the at least one second cell.

A method for wireless communication by a user equipment (UE) is described. The method comprises: receiving at least one first downlink signal from at least one first cell in a semi-active state corresponding to an energy-saving mode of operation of the at least one first cell, wherein the at least one first downlink signal is configured to indicate that at least one frequency channel is within a pre-configured range on a frequency raster; receiving at least one second downlink signal from at least one second cell in a semi-active state corresponding to an energy-saving mode of operation of the at least one second cell, wherein the at least one second downlink signal is configured to indicate that the at least one frequency channel is not within a pre-configured range on a frequency raster; detecting, based at least in part on the one first downlink signal and the at least one second downlink signal, a synchronization signal transmitted on the at least one frequency channel from at least one cell in an active state; and establishing a connection with the at least one cell in the active state based at least in part on the synchronization signal.

In some examples of the method, apparatuses, and non-transitory computer-readable medium described herein may operate in a 6 gigahertz (GHz) frequency band and the cell or cells may correspond to a base station (e.g., gNB). The cell(s) in the semi-active state and the cell(s) in the active state may belong to the same base station of they may belong to different base stations. Alternatively, a cell may be identified as a base station.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 shows an example of a system for wireless communications that supports methods for power/energy savings in accordance with aspects of the present disclosure.

FIGS. 2A-2B show examples of network configurations of a wireless communication subsystem in accordance with aspects of the present disclosure.

FIGS. 3A-3B show other examples network configurations of wireless communication subsystem in accordance with aspects of the present disclosure.

FIGS. 4A-4B show an example of a wireless communication subsystem that supports methods for energy savings in accordance with aspects of the present disclosure.

FIG. 5 shows an example of synchronization rasters in accordance with aspects of the present disclosure.

FIGS. 6A-6C show examples of synchronization rasters in accordance with aspects of the present disclosure.

FIGS. 7A-7B show further examples of synchronization rasters in accordance with aspects of the present disclosure.

FIG. 8 shows a message exchange diagram involving a cell in semi-active state and a UE in accordance with aspects of the present disclosure.

FIG. 9 shows a message exchange diagram involving a cell in semi-active state, a cell in active state, and a UE in accordance with aspects of the present disclosure.

FIG. 10 shows a flowchart of a method at a cell for energy savings in accordance with aspects of the present disclosure.

FIG. 11 shows a flowchart of a method at a cell for energy savings in accordance with further aspects of the present disclosure.

FIG. 12 shows another flowchart of a method at a cell for energy savings in accordance with further aspects of the present disclosure.

FIG. 13 shows a method at a cell for energy savings in accordance with particular aspects of the present disclosure.

FIG. 14 shows another flowchart of a method at a cell for energy savings in accordance with some further aspects of the present disclosure.

FIG. 15 shows a flowchart of a method at a UE for energy savings in accordance with aspects of the present disclosure.

FIG. 16 shows another flowchart of a method at a UE for energy savings in accordance with aspects of the present disclosure.

FIG. 17 shows a diagram of an apparatus at a base station that supports energy savings in accordance with aspects of the present disclosure.

FIG. 18 shows a block diagram of an apparatus at a base station that supports energy saving in accordance with aspects of the present disclosure.

FIG. 19 shows a diagram of an apparatus at a UE that supports energy savings in accordance with aspects of the present disclosure.

FIG. 20 shows a block diagram of an apparatus at a UE that supports energy savings in accordance with aspects of the present disclosure.

### DETAILED DESCRIPTION

Methods and apparatuses are described herein that can provide superior power/energy savings at the network nodes (e.g., cells). In the context of the present disclosure the terms power and energy may be used interchangeably. While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

Power consumed at a wireless device, such as a user equipment (UE), may be proportionate to the carrier frequency. Moreover, some of the power may be converted to heat, so that regulations of wireless communications put an upper threshold on the transmission power that an antenna, or antenna module, can use when human tissue is proximate to the antenna. For example, a maximum permissible exposure (MPE) limit may be defined in terms of a maximum power density over a given frequency range.

Power savings at a wireless device may be achieved with various approaches. For example, reducing the transmission power may reduce the effective isotropic radiated power (EIRP) but may negatively impact the range of communications. Therefore, in one approach establishing a relay link over a relay node (i.e., a relay station) may enable communications at a lower transmission power level than that used for a direct communication link, thus resulting in power savings at the wireless device while preserving the communications range. Moreover, establishing a relay link may also enable communications that would otherwise cause a wireless device to exceed the MPE. Another power saving approach comprises dropping carriers in shared access (SA), dual carrier connection involving Evolved Universal Terrestrial Radio Access and New Radio (EN-DC), and other systems. Other approaches to improve power savings at a wireless device may comprise reducing a MIMO rank, reducing the number of antennas used, using a lower order modulation and coding scheme (MCS), switching the antenna module used or RFIC used, or disabling the radio.

A related aspect of power savings at a wireless device (e.g., UE) are power/energy savings at network nodes (e.g., cells). Therefore, it is desired to develop techniques and features to let network nodes save energy in addition to the techniques for UE's power savings. For example, in a wireless communication system, such as 5G NR, only very few cells may be active and sending synchronization signal blocks (SSB), respectively, cell defining SSBs (CD-SSBs). As a result, many of the synchronization rasters in a 5G NR network would be idle, and the frequency scan by the UEs (e.g., for initial system access) would consume too much time and power. Hence, a problem to be addressed is how to enable network power/energy savings without negatively impacting the UE power savings.

The techniques described herein add an option for a cell to enter a semi-active state, which from the perspective of energy/power consumption and/or functionality and/or latency may be considered to represent an intermediary state between an inactive state and an active state. According to various aspects of the present disclosure, a cell may be at one time in one of an inactive state, an active state, and in (at least) one semi-active state. The cell may transition between any of the states, for example, in response to an event (e.g., a condition being fulfilled, a trigger signal, a timer, etc.).

The inactive state may correspond to a state with low energy/power consumption and/or limited functionality, for example, a state in which the cell may respond only to a trigger signal instructing the cell to switch into a state with higher energy/power consumption and/or more functionality. In some aspects, the energy/power consumption in the inactive state may be below a first energy/power threshold, P_{TH1}. Therefore, the inactive state may be considered an energy-saving mode of operation. One drawback associated with a cell in the inactive state may be the latency of the cell for responding to trigger signals, which may be the highest among all energy/power states of the cell.

The semi-active state may also correspond to an energy-saving mode of operation, in which the energy/power consumption at the cell may only be slightly higher than in the inactive state (e.g., at its peak and/or on the average). In some aspects, the energy/power consumption of a cell in the semi-active state may be above the first energy/power threshold, P_{TH1}, but below a second energy/power threshold, P_{TH2}. During the at least one semi-active state, the cell is capable of a reduced mode of operation, in particular, it may send and/or receive a reduced number of signals. For example, a cell in a semi-active state may send a downlink signal, which may be periodical, and which may be conveniently referred to as an assisted frequency scan (AFS) signal. The AFS signal may be configured to assist at least one UE receiving the signal to find (i.e., detect) at least one cell in an active state. The latency of a cell in the semi-active state may be lower than the latency of the cell in the inactive state. In some aspects, there may be multiple semi-active states, each one characterized by different energy/power thresholds, functionality, and latencies.

The active state may correspond to an energy-intensive mode of operation of the cell, i.e., a mode of operation in which the energy/power consumption of the cell may be the highest (e.g., at its peak and/or on the average) among all the states. In particular, the energy/power consumption during the active state may be higher than the energy/power consumption during the at least one semi-active state, for example, it may be higher than the second energy/power threshold, P_{TH2}, defining the upper limit of the energy/power consumption for the one (or more) semi-active state(s). In some aspects, a cell in the active state may transmit with higher than nominal power in order to compensate for coverage gaps of neighboring cells in inactive or semi-active states corresponding to one or more energy-saving modes of operation of the respective cells. During the active state the cell is fully operational, and its latency may be the lowest among all the states. In some aspects, the latency of the cell in a state may be inversely proportional with its power consumption.

A cell in the active state may also be referred to as an active cell, a cell in the (at least one) semi-active state may also be referred to as a semi-active cell, and a cell in the inactive state may also be referred to as an inactive cell. In some aspects, the cell(s) in the semi-active state(s) and the cell(s) in the active state may belong to the same base station or to different base stations. Alternatively, a cell may be identified as a base station. The term cell is used interchangeably to refer to a base station, a subcomponent of a base station, or the coverage area of a base station. A base station may also be denoted as gNB or gNodeB.

A UE may receive the downlink signal (i.e., the AFS signal) transmitted by a cell in a semi-active state and detect based at least in part on the downlink signal, at least one synchronization signal (i.e., SSB/CD-SSB) transmitted by at least one cell in an active state. The UE may subsequently access the network via the cell in the active state.

As a result, energy savings are realized both in the network by allowing non-serving cells to enter a semi-active state corresponding to an energy saving mode of operation and also at the UEs attempting to access the network by providing them with further guidance in the form of specially configured downlink signals, also referred herein as AFS signals, which allows them to find a cell in an active state sending SSBs/CD-SSBs.

Since the AFS signals are not required to provide as much information as SSBs/CD-SSBs they may be specifically designed with power/energy savings in mind, i.e., they may occupy only one or two symbols, e.g., Orthogonal Frequency Division Multiplex (OFDM) symbols. In contrast, an SSB/CD-SSB typically occupies four OFDM symbols.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

Aspects of the disclosure are initially described in the context of a wireless communications system. Aspects of the disclosure are further illustrated by and described with reference to apparatus diagrams, subsystem diagrams, and method flowcharts.

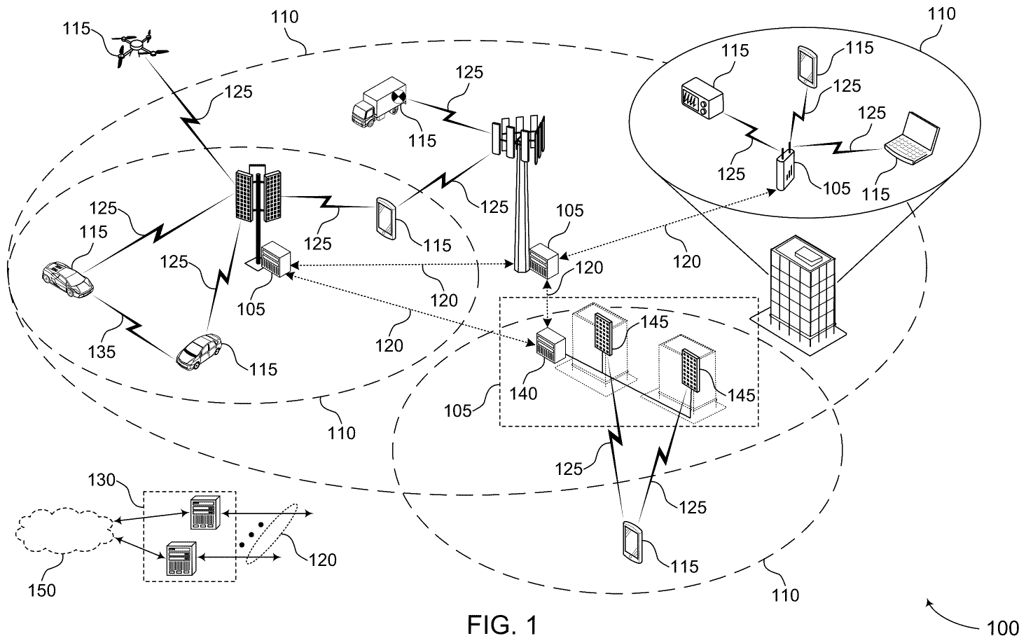

FIG. 1 illustrates an example of a wireless communications system 100 that supports methods for energy savings in accordance with aspects of the present disclosure. The wireless communications system 100 may include base stations 105, UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (for example, mission critical) communications, low latency communications, communications with low-cost and low-complexity devices, or any combination thereof.

Base stations 105 may be dispersed throughout a geographic area to form the wireless communications system 100 and may be devices in different forms or having different capabilities. In some aspects, the term “base station” (e.g., the base station 105) or “network node” or “network entity” may refer to an aggregated base station, a disaggregated base station, an integrated access and backhaul (IAB) node, a relay node, and/or one or more components thereof. For example, in some aspects, “base station,” “network node,” or “network entity” may refer to a Central Unit (CU), a Distributed Unit (DU), a Radio Unit (RU), a Near-Real Time (Near-RT) Radio Access Network (RAN) Intelligent Controller (RIC), or a Non-Real Time (Non-RT) RIC, or a combination thereof.

In some aspects, the term “base station,” “network node,” or “network entity” may refer to one device configured to perform one or more functions, such as those described herein in connection with the base station 105. In some aspects, the term “base station,” “network node,” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station,” “network node,” or “network entity” may refer to any one or more of those different devices. In some aspects, the term “base station,” “network node,” or “network entity” may refer to one or more virtual base stations and/or one or more virtual base station functions. For example, in some aspects, two or more base station functions may be instantiated on a single device. In some aspects, the term “base station,” “network node,” or “network entity” may refer to one of the base station functions and not another. In this way, a single device may include more than one base station.

Base stations 105 and UEs 115 may wirelessly communicate via one or more communication links 125. Each base station 105 may provide a coverage area 110 over which UEs 115 and the base station 105 may establish communication links 125. The coverage area 110 may be an example of a geographic area over which a base station 105 and a UE 115 support the communication of signals according to one or more radio access technologies. In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, overlapping geographic coverage areas 110 associated with different technologies may be supported by different base stations 105. The wireless communications system 100 may include, for example, a heterogeneous network in which different types of base stations 105 provide coverage for various geographic coverage areas 110 using the same or different radio access technologies.

Each base station 105 may provide communication coverage via one or more cells, for example a macro cell, a small cell, a hot spot, or other types of cells, or various combinations thereof. The term “cell” may refer to a logical communication entity used for communication with a base station 105 (for example, over a carrier) and may be associated with an identifier for distinguishing neighboring cells (for example, a physical cell identifier (PCID), a virtual cell identifier (VCID), or others). In some examples, a cell may also refer to a geographic coverage area 110 or a portion of a geographic coverage area 110 (for example, a sector) over which the logical communication entity operates. Such cells may range from smaller areas (for example, a structure, a subset of structure) to larger areas depending on various factors such as the capabilities of the base station 105. For example, a cell may be or include a building, a subset of a building, exterior spaces between or overlapping with geographic coverage areas 110, among other examples.

A macro cell generally covers a relatively large geographic area (for example, several kilometers in radius) and may allow unrestricted access by UEs 115 with service subscriptions with the network provider supporting the macro cell. A small cell may be associated with a lower-powered base station 105, as compared with a macro cell, and a small cell may operate in the same or different (for example, licensed, unlicensed) frequency spectrum bands as macro cells. Small cells may provide unrestricted access to UEs 115 with service subscriptions with the network provider or may provide restricted access to UEs 115 having an association with the small cell (for example, UEs 115 in a closed subscriber group (CSG), UEs 115 associated with users in a home or office, among other examples). A base station 105 may support one or multiple cells and may also support communications over the one or more cells using one or multiple component carriers.

One or more of base stations 105 may include or may be referred to by a person of ordinary skill in the art as a base transceiver station, a radio base station, an access point, a radio transceiver, a NodeB, an eNodeB (eNB), a next-generation NodeB or giga-NodeB (either of which may be referred to as a gNB), a Home NodeB, a Home eNodeB, or other suitable terminology. A gNB may comprise a gNB Central Unit (gNB-CU) and one or more gNB Distributed Units (gNB-DUs). The gNB-CU terminates the F1 interface connected with the gNB-DU. The operation of a gNB-DU is partly controlled by gNB-CU. One gNB-DU may support one or multiple cells. One cell may be supported by one gNB-DU.

UEs 115 may be dispersed throughout a coverage area 110 of the wireless communications system 100, and each UE 115 may be stationary, or mobile, or both at different times. UEs 115 may be devices in different forms or having different capabilities. Some example UEs 115 are illustrated with reference to FIG. 1. The UEs 115 may be able to communicate with various types of devices, such as other UEs 115, base stations 105, or network equipment (for example, core network nodes, relay devices, integrated access and backhaul (IAB) nodes, or other network equipment), as shown with reference to FIG. 1.

Base stations 105 may communicate with the core network 130, or with one another, or both. For example, base stations 105 may interface with the core network 130 through backhaul links 120 (for example, via an S1, N2, N3, or other interface). Base stations 105 may communicate with one another over backhaul links 120 (for example, via an X2, Xn, or other interface) either directly (for example, directly between base stations 105), or indirectly (for example, via core network 130), or both. In some examples, backhaul links 120 may be or include one or more wireless links.

A UE 115 may include or may be referred to as a mobile device, a wireless device, a remote device, a handheld device, or a subscriber device, or some other suitable terminology, in which the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, meters, among other examples.

The UEs 115 may be able to communicate with various types of devices, such as other UEs 115 that may sometimes act as relays as well as base stations 105 and network equipment including macro eNBs or gNBs, small cell eNBs or gNBs, or relay base stations, among other examples, as shown with reference to FIG. 1. UEs 115 and base stations 105 may wirelessly communicate with one another via one or more communication links 125 over one or more carriers. In some examples, a carrier may support multiple cells, and different cells may be configured according to different protocol types (for example, MTC, narrowband IoT (NB-IoT), enhanced mobile broadband (eMBB), or others) that may provide access for different types of devices. The term “carrier” may refer to a set of radio frequency spectrum resources having a defined physical layer structure for supporting communication links 125. For example, a carrier used for a communication link 125 may include a portion of a radio frequency spectrum band that is operated according to physical layer channels for a given radio access technology (for example, LTE, LTE-A, LTE-A Pro, NR). Each physical layer channel may carry acquisition signaling (for example, synchronization signals, system information), control signaling that coordinates operation for the carrier, user data, or other signaling. In some examples, the receive and transmit band of a UE 115 may not need be as large as the bandwidth of the cell and may be adjusted in a process which may be referred to as bandwidth adaptation (BA), i.e., the width may be ordered to change (e.g., to shrink during period of low activity to save power), the location may move in the frequency domain (e.g., to increase scheduling flexibility), and the subcarrier spacing may be ordered to change (e.g., to allow different services). A subset of the total cell bandwidth of a cell may be referred to as bandwidth part (BWP) and BA may be achieved by configuring the UE with BWP(s) and telling the UE which of the configured BWPs is currently the active one.

The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (for example, in a carrier aggregation configuration), a carrier may also have acquisition signaling or control signaling that coordinates operations for other carriers. A carrier may be associated with a frequency channel (for example, an evolved universal mobile telecommunication system terrestrial radio access (E-UTRA) absolute radio frequency channel number (EARFCN)) and may be positioned according to a channel raster for discovery by UEs 115. A carrier may be operated in a standalone mode in which initial acquisition and connection may be conducted by UEs 115 via the carrier, or the carrier may be operated in a non-standalone mode in which a connection is anchored using a different carrier (for example, of the same or a different radio access technology).

Communication links 125 shown in the wireless communications system 100 may include uplink transmissions from a UE 115 to a base station 105, or downlink transmissions from a base station 105 to a UE 115. Carriers may carry downlink or uplink communications (for example, in an FDD mode) or may be configured to carry downlink and uplink communications (for example, in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (for example, 1.4, 3, 5, 10, 15, 20, 40, or 80 megahertz (MHz)). Devices of the wireless communications system 100 (for example, base stations 105, UEs 115, or both) may have hardware configurations that support communications over a particular carrier bandwidth or may be configurable to support communications over one of a set of carrier bandwidths. In some examples, the wireless communications system 100 may include base stations 105 and UEs 115 that support simultaneous communications via carriers associated with multiple carrier bandwidths. In some examples, each served UE 115 may be configured for operating over portions (for example, a sub-band, a BWP) or all of a carrier bandwidth.

Signal waveforms transmitted over a carrier may be made up of multiple subcarriers (for example, using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (for example, a duration of one modulation symbol) and one subcarrier, in which the symbol period and subcarrier spacing are inversely related. The number of bits carried by each resource element may depend on the modulation scheme (for example, the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (for example, spatial layers or beams), and the use of multiple spatial layers may further increase the data rate or data integrity for communications with a UE 115.

One or more numerologies for a carrier may be supported, in which a numerology may include a subcarrier spacing (Δf) and a cyclic prefix. A carrier may be divided into BWPs having the same or different numerologies. In some examples, a UE 115 may be configured with multiple BWPs. In some examples, a single BWP for a carrier is active at a given time, and communications for the UE 115 may be restricted to active BWPs. Time intervals for base stations 105 or UEs 115 may be expressed in multiples of a basic time unit which may, for example, refer to a sampling period of Tₛ=1/(Δfₘₐₓ·N_{f}) seconds, in which Δfₘₐₓ may represent the maximum supported subcarrier spacing, and N_{f} may represent the maximum supported discrete Fourier transform (DFT) size. Time intervals of a communications resource may be organized according to radio frames each having a specified duration (for example, 10 milliseconds (ms)). Each radio frame may be identified by a system frame number (SFN) (for example, ranging from 0 to 1023).

Each frame may include multiple consecutively numbered subframes or slots, and each subframe or slot may have the same duration. In some examples, a frame may be divided (for example, in the time domain) into subframes, and each subframe may be further divided into a number of slots. Alternatively, each frame may include a variable number of slots, and the number of slots may depend on subcarrier spacing. Each slot may include a number of symbol periods (for example, depending on the length of the cyclic prefix prepended to each symbol period). In some wireless communications systems 100, a slot may further be divided into multiple mini-slots containing one or more symbols. Excluding the cyclic prefix, each symbol period may contain one or more (for example, N^{f}) sampling periods. The duration of a symbol period may depend on the subcarrier spacing or frequency spectrum band of operation.

A subframe, a slot, a mini-slot, or a symbol may be the smallest scheduling unit (for example, in the time domain) of the wireless communications system 100 and may be referred to as a transmission time interval (TTI). In some examples, the TTI duration (for example, the number of symbol periods in a TTI) may be variable. Additionally, or alternatively, the smallest scheduling unit of the wireless communications system 100 may be dynamically selected (for example, in bursts of shortened TTIs (sTTIs)).

Physical channels may be multiplexed on a carrier according to various techniques. A physical control channel and a physical data channel may be multiplexed on a downlink carrier, for example, using time division multiplexing (TDM) techniques, frequency division multiplexing (FDM) techniques, or hybrid TDM-FDM techniques. A control region (for example, a control resource set (CORESET)) for a physical control channel may be defined by a number of symbol periods and may extend across the system bandwidth or a subset of the system bandwidth of the carrier. One or more control regions (for example, CORESETs) may be configured for a set of UEs 115. For example, the UEs 115 may monitor or search control regions for control information according to one or more search space sets, and each search space set may include one or multiple control channel candidates in one or more aggregation levels arranged in a cascaded manner Δn aggregation level for a control channel candidate may refer to a number of control channel resources (for example, control channel elements (CCEs)) associated with encoded information for a control information format having a given payload size. Search space sets may include common search space sets configured for sending control information to multiple UEs 115 and UE-specific search space sets for sending control information to a specific UE 115.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques may be used for either synchronous or asynchronous operations.

Some UEs 115, such as MTC or IoT devices, may be low cost or low complexity devices and may provide for automated communication between machines (for example, via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (for example, a mode that supports one-way communication via transmission or reception, but not transmission and reception simultaneously). In some examples, half-duplex communications may be performed at a reduced peak rate. Other power conservation techniques for UEs 115 include entering a power saving deep sleep mode when not engaging in active communications, operating over a limited bandwidth (for example, according to narrowband communications), or a combination of these techniques. For example, some UEs 115 may be configured for operation using a narrowband protocol type that is associated with a defined portion or range (for example, set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. UEs 115 may be designed to support ultra-reliable, low-latency, or critical functions (for example, mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (for example, using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of UEs 115 communicating via D2D communications may utilize a one-to-many (1:M) system in which each UE 115 transmits to every other UE 115 in the group. In some examples, a base station 105 facilitates the scheduling of resources for D2D communications. In other examples, D2D communications are carried out between UEs 115 without the involvement of a base station 105.

In some systems, the D2D communication link 135 may be an example of a communication channel, such as a sidelink communication channel, between vehicles (for example, UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (for example, base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (for example, a mobility management entity (MME), an access and mobility management function (AMF)) and at least one user plane entity that routes packets or interconnects to external networks (for example, a serving gateway (S-GW), a Packet Data Network (PDN) gateway (P-GW), a user plane function (UPF)). The control plane entity may manage non-access stratum (NAS) functions such as mobility, authentication, and bearer management for UEs 115 served by base stations 105 associated with the core network 130. User IP packets may be transferred through the user plane entity, which may provide IP address allocation as well as other functions. The user plane entity may be connected to the network operators IP services 150. The operators IP services 150 may include access to the Internet, an Intranet, an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with UEs 115 through a number of other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (for example, radio heads and ANCs) or consolidated into a single network device (for example, a base station 105).

The wireless communications system 100 may operate using one or more radio frequency spectrum bands, typically in the range of 300 megahertz (MHz) to 300 gigahertz (GHz). Generally, the region from 300 MHz to 3 GHz is known as the ultra-high frequency (UHF) region or decimeter band, as the wavelengths range from approximately one decimeter to one meter in length. UHF waves may be blocked or redirected by buildings and environmental features, but the waves may penetrate structures sufficiently for a macro cell to provide service to UEs 115 located indoors. Transmission of UHF waves may be associated with smaller antennas and shorter ranges (for example, less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using radio frequency spectrum bands from 3 GHz to 30 GHz, also known as the centimeter band, or in an extremely high frequency (EHF) region of the spectrum (for example, from 30 GHz to 300 GHz), also known as the millimeter band. In some examples, the wireless communications system 100 may support millimeter wave (mmW) communications between UEs 115 and base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. Techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as base stations 105 and UEs 115 may employ carrier sensing for collision detection and avoidance. In some examples, operations in unlicensed bands may be based on a carrier aggregation configuration in conjunction with component carriers operating in a licensed band (for example, LAA). Operations in unlicensed spectrum may include downlink transmissions, uplink transmissions, P2P transmissions, or D2D transmissions, among other examples.

A base station 105 or UE 115 may be equipped with multiple antennas, which may be used to employ techniques such as transmit diversity, receive diversity, multiple-input multiple-output (MIMO) communications, or beamforming. The antennas of a base station 105 or UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

Base stations 105 or UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (for example, the same codeword) or different data streams (for example, different codewords). Different spatial layers may be associated with different antenna ports used for channel measurement and reporting. MIMO techniques include single-user MIMO (SU-MIMO), in which multiple spatial layers are transmitted to the same receiving device, and multiple-user MIMO (MU-MIMO), in which multiple spatial layers are transmitted to multiple devices.

Beamforming, which may also be referred to as spatial filtering, directional transmission, or directional reception, is a signal processing technique that may be used at a transmitting device or a receiving device (for example, a base station 105 or a UE 115) to shape or steer an antenna beam (for example, a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (for example, with respect to the antenna array of the transmitting device or receiving device, or with respect to some other orientation).

A base station 105 or UE 115 may use beam sweeping techniques as part of beam forming operations. For example, a base station 105 may use multiple antennas or antenna arrays (for example, antenna panels) to conduct beamforming operations for directional communications with a UE 115. Some signals (for example, synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (for example, by a transmitting device, such as a base station 105, or a receiving device, such as a UE 115) a beam direction for subsequent transmission and reception by the base station 105.

Some signals, such as data signals associated with a particular receiving device, may be transmitted by a base station 105 in a single beam direction (for example, a direction associated with the receiving device, such as a UE 115). In some examples, the beam direction associated with transmissions along a single beam direction may be determined based on a signal that was transmitted in different beam directions. For example, a UE 115 may receive one or more of the signals transmitted by the base station 105 in different directions and may report to the base station 105 an indication of the signal that the UE 115 received with a highest signal quality, or an otherwise acceptable signal quality.

In some examples, transmissions by a device (for example, by a base station 105 or UE 115) may be performed using multiple beam directions, and the device may use a combination of digital precoding or radio frequency beamforming to generate a combined beam for transmission (for example, from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (for example, a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (for example, a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (for example, for determining a beam direction for subsequent transmission or reception by the UE 115) or for transmitting a signal in a single direction (for example, for transmitting data to a receiving device).

A receiving device (for example, a UE 115) may try multiple receive configurations (for example, directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (for example, different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (for example, when receiving a data signal). The single receive configuration may be aligned in a beam direction determined based on listening according to different receive configuration directions (for example, a beam direction determined to have a highest signal strength, highest signal-to-noise ratio (SNR), or otherwise acceptable signal quality based on listening according to multiple beam directions).

As part of directional communications, the one or more of the base stations 105 or the UEs 115 may support beam management for one or more downlink receive directional beams corresponding to one or more physical downlink channels or one or more uplink transmit directional beams corresponding to one or more physical uplink channels. In some examples, beam management may include performing a beam switch from one or more downlink receive directional beams to one or more alternative downlink receive directional beams, or from one or more uplink transmit directional beams to one or more alternative uplink transmit directional beams to improve communications between the one or more of the base stations 105 or the UEs 115 or between the different UEs 115. In some examples, the alternative directional beams may have one or more of a higher reference signal received power (RSRP), a smaller SNR, or a smaller signal to interference and noise ratio (SINR), as compared to existing directional beams used by one or more of the base stations 105 or the UEs 115.

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or core network 130 supporting radio bearers for user plane data. At the Physical (PSY) layer, transport channels may be mapped to physical channels.

UEs 115 and base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (for example, using a cyclic redundancy check (CRC)), forward error correction (FEC), and retransmission (for example, automatic repeat request (ARQ)). HARQ may improve throughput at the MAC layer in poor radio conditions (for example, low signal-to-noise conditions). In some examples, a device may support same-slot HARQ feedback, in which the device may provide HARQ feedback in a specific slot for data received in a previous symbol in the slot. In other examples, the device may provide HARQ feedback in a subsequent slot, or according to some other time interval.

One or more of base stations 105 or UEs 115 may support directional communications in the wireless communications system 100. Directional communications may include one or more downlink receive directional beams corresponding to one or more physical downlink channels or one or more uplink transmit directional beams corresponding to one or more physical uplink channels. The one or more physical downlink channels may include one or more of a physical downlink control channel (PDCCH), a physical downlink shared channel (PDSCH) or a synchronization signal physical broadcast channel (SS/PBCH) block, and the one or more physical uplink channels may include one or more of a physical uplink control channel (PUCCH) or a physical uplink shared channel (PUSCH). In some examples, the one or more of the base stations 105 or the UEs 115 may perform a beam sweep procedure to determine and select one or more downlink receive directional beams and one or more uplink transmit directional beams to establish a connection.

In some examples, the one or more of the base stations 105 or the UEs 115 may support directional communications in one or more radio frequency spectrum bands. In some examples, a radio frequency spectrum band may be defined by a range of radio frequencies (f) within the radio frequency spectrum band. For example, a first frequency range (FR1) may have a frequency range between 410 MHz and 7.125 GHz (410 MHz<f<7.125 GHz), a second frequency range (FR2) may have a different frequency range from FR1, for example, between 24.25 GHz and 52.6 GHz (24.25 GHz<f<52.6 GHz), while a third frequency range (FR3) may have a different frequency range from FR1 and FR2, for example, between 7.125 GHz and 24.25 GHz (7.125 GHz<f<24.25 GHz). In some examples, one or more of FR1, FR2, or FR3 may be referred to as a low radio frequency spectrum band. As such, in some examples, the one or more of the base stations 105 or the UEs 115 may support directional communications in low radio frequency spectrum bands.

Additionally, or alternatively, the one or more of the base stations 105 or the UEs 115 may support directional communications in one or more high radio frequency spectrum bands. A high radio frequency spectrum band may refer to a radio frequency spectrum band that is greater than or equal to a frequency (f) (for example, greater than 52.6 GHz). In some examples, a radio frequency spectrum band including frequencies between 52.6 GHz and 114.25 GHz (52.6 GHz<f<114.25 GHz) may be referred to as a fourth frequency range (FR4), while a radio frequency spectrum band including frequencies between 114.25 GHz and 275 GHz (114.25 GHz<f<275 GHz) may be referred to as a fifth frequency range (FR5). Therefore, FR4 and FR5 may be referred to as high radio frequency spectrum bands.

Each radio frequency spectrum band, such as FR1, FR2, FR3, FR4 and FR5 may relate to a transmission numerology. Table 1 below defines examples of different transmission numerologies. In some examples, the one or more of the base stations 105 or the UEs 115 may support one or more transmission numerologies as defined in Table 1. Each numerology in Table 1 may be labeled as a parameter μ. In some examples, the numerology may be based on exponentially scalable subcarrier spacing Δf=2^{μ}×15 kHz with μ={0,1,2,3,4}. As defined in Table 1, a numerology (μ=0) represents a subcarrier spacing of 15 kHz. Among other examples, as defined in Table 1, numerology (μ=1) represents a subcarrier spacing of 30 kHz, numerology (μ=2) represents a subcarrier spacing of 60 kHz, numerology (μ=3) represents a subcarrier spacing of 120 kHz, and numerology (μ=4) represents a subcarrier spacing of 240 kHz.

TABLE 1
Transmission Numerologies.

| | | | Supported | Supported |
|---|---|---|---|---|
| μ | Δf = 2^{μ} · 15[kHz] | Cyclic Prefix | for Data | for Synch |
| 0 | 15 | Normal | Yes | Yes |
| 1 | 30 | Normal | Yes | Yes |
| 2 | 60 | Normal, Extended | Yes | No |
| 3 | 120 | Normal | Yes | Yes |
| 4 | 240 | Normal | No | Yes |

By way of example, radio frequency spectrum band FR1 may relate to transmission numerologies μ={0,1,2}. For example, radio frequency spectrum band FR1 may support subcarrier spacings of 15 kHz, 30 kHz, and 60 kHz, which may correspond to a symbol duration of approximately 71 microseconds (μs), 36 μs, and 18 μs, respectively. The symbol duration (for example, approximately 71 μs, 36 μs, and 18 μs) may include a duration of a cyclic prefix of the symbol. The base stations 105 or the UE 115 may prepend a cyclic prefix to each symbol to improve transmission of the symbol. A cyclic prefix may represent a guard period at a beginning of each symbol that may improve transmission reliability of the symbol by providing protection against one or more factors in the wireless communications system 100, such as multipath delay spread. Among other examples, radio frequency spectrum band FR2 may relate to transmission numerologies μ={2,3,4}. For example, radio frequency spectrum band FR2 may support subcarrier spacings of 60 kHz, 120 kHz, and 240 kHz, which may correspond to symbol durations of approximately 18 μs, 9 μs, and 4.5 μs, respectively. Similarly, the symbol duration (for example, approximately 18 μs, 9 μs, and 4.5 μs) may include a duration of a cyclic prefix for the symbol.

In some examples, as shown in Table 1, a duration of a cyclic prefix may depend on the transmission numerology. That is, a duration of a cyclic prefix may be shorter or greater in length based on the transmission numerology. For example, a cyclic prefix may have a duration of 4.7 μs for a 15 kHz subcarrier spacing (for example, numerology μ=0), and 0.57 μs for a 120 kHz subcarrier spacing (for example, numerology μ=3). In some examples, as defined in Table 1, a normal cyclic prefix may be supported for each subcarrier spacing (for example, for each transmission numerology), while an extended cyclic prefix may be supported exclusively for numerology μ=2. A normal cyclic prefix may be shorter in length compared to an extended cyclic prefix. For example, a normal cyclic prefix may have a duration of 4.7 μs, while an extended cyclic prefix may have a duration of 16.7 μs. As demand for communication efficiency increases, the wireless communications system 100 may support larger subcarrier spacings for one or more high radio frequency spectrum bands (for example, FR4 and FR5). Some examples of the wireless communications system 100 may support one or more of subcarrier spacings of 480 kHz, 960 kHz, 1.92 MHz, or 3.84 MHz for one or more high radio frequency spectrum bands (for example, FR4 and FR5). However, the wireless communications system 100 is not limited to the above examples of subcarrier spacings (for example, 480 kHz, 960 kHz, 1.92 MHz, or 3.84 MHz), as other subcarrier spacings may be supported in the wireless communications system 100.

In some examples, for radio frequency spectrum band FR2, the base stations 105 or the UEs 115 may support a 240 kHz subcarrier spacing exclusively for synchronization signal blocks (SSBs). In general, the term “SSB” may commonly refer to a synchronization signal and PBCH block. The SSB may span across four OFDM symbols and may comprise the primary synchronization signal (PSS), the secondary synchronization signal (SSS) and the PBCH. The PSS and SSS may occupy each one OFDM symbol and 127 subcarriers, while the PBCH may span across three OFDM symbols and 240 subcarriers but leaving an unused range of 127 subcarriers in the middle for the SSS in one of the three OFDM symbols. The periodicity of the SSB may be configurable by the network and the time locations where SSB can be sent may be determined by subcarrier spacing. In some examples, within the frequency span of a carrier, multiple SSBs may be transmitted, and the physical cell identifiers (PCIs) of those SSBs do not have to be unique, i.e., different SSBs may have different PCIs. However, in some examples, when an SSB is associated with remaining minimum system information (RMSI), the SSB may correspond to an individual cell, which may have a unique NR cell global identifier (NCGI). Such an SSB may then be referred to as a cell-defining SSB (CD-SSB).

In related aspects, the term “global channel raster” may refer to a set of radio frequency (RF) reference frequencies, wherein a RF reference frequency may be used in signaling to identify the position of RF channels, SSBs, and other elements in a wireless communication system, such as NR. In particular, RF frequencies may be designated by an NR Absolute Radio Frequency Channel Number (NR-ARFCN) on the global frequency raster. In some examples, the global frequency raster may be defined for all frequencies from 0 to 100 GHz with a granularity denoted as ΔF_{Global}, which may depend on a frequency range. For example, ΔF_{Global} may be equal to 5 kHz in a frequency range from 0 to 3 GHz, 15 kHz in a frequency range from 3 GHz to 24.25 GHz, and 60 kHz and in a frequency range from 24.25 GHz to 100 GHz. In other related aspects, the term “channel raster” may refer to a set of RF reference frequencies F_{REF} that may be used to identify the RF channel position in the uplink and downlink. The RF reference frequency for an RF channel may map to a resource element on a carrier. For each operating band, which may be predefined, only a subset of frequencies from the global frequency raster may be applicable for that band and may form a channel raster with a granularity ΔF_{Raster}, which may be equal to or larger than ΔF_{Global}.

In some related aspects, the term “synchronization raster” may be used to refer to the frequency positions of the SSB, that can be used by the UE for system acquisition when explicit signaling of the SSB position is not present. A global synchronization raster may be defined for all frequencies. For example, in a wireless communication system such as NR, the frequency position of the SSB may be defined as SS_{REF} with corresponding Global Synchronization Channel Number (GSCN). The synchronization raster and the subcarrier spacing of the SSB may be defined separately for each operating band, which may therefore be regarded as a plurality of different synchronization rasters. In some examples, the operating bands may correspond to those defined in Table 2 for NR FR2.

TABLE 2
NR operating bands in FR2

| | Uplink (UL) | Downlink (DL) | |
|---|---|---|---|
| | operating band | operating band | |
| | BS receive | BS transmit | |
| Operating | UE transmit | UE receive | Duplex |
| Band | F_{UL}_{_{—}}_{low}-F_{UL}_{_{—}}_{high} | F_{DL}_{_{—}}_{low}-F_{DL}_{_{—}}_{high} | Mode |
| n257 | 26500 MHz-29500 MHz | 26500 MHz-29500 MHz | TDD |
| n258 | 24250 MHz-27500 MHz | 24250 MHz-27500 MHz | TDD |
| n259 | 39500 MHz-43500 MHz | 39500 MHz-43500 MHz | TDD |
| n260 | 37000 MHz-40000 MHz | 37000 MHz-40000 MHz | TDD |
| n261 | 27500 MHz-28350 MHz | 27500 MHz-28350 MHz | TDD |

In some examples, the synchronization raster for each operating band shown in Table 2 may be defined as indicated in Table 3, wherein the distance between GSCN entries may be given by the <Step size>. The SSB pattern may correspond either to Case D (SCS: 120 kHz, the first symbols of the candidate SS/PBCH blocks have indexes {4, 8, 16, 20}+28·n, with n=0, 1, 2, 3, 5, 6, 7, 8, 10, 11, 12, 13, 15, 16, 17, 18 for carrier frequencies within FR2) or to Case E (SCS: 240 kHz, the first symbols of the candidate SS/PBCH blocks (SSBs) have indexes {8, 12, 16, 20, 32, 36, 40, 44}+56·n, with n=0, 1, 2, 3, 5, 6, 7, 8 for carrier frequencies within FR2).

TABLE 3
Applicable SS raster entries per operating band.

| NR Operating | | | Range of GSCN |
|---|---|---|---|
| Band | SSB SCS | SSB pattern | (First-<Step size>-Last) |
| n257 | 120 kHz | Case D | 22388-<1>-22558 |
| | 240 kHz | Case E | 22390-<2>-22556 |
| n258 | 120 kHz | Case D | 22257-<1>-22443 |
| | 240 kHz | Case E | 22258-<2>-22442 |
| n259 | 120 kHz | Case D | 23140-<1>-23369 |
| | 240 kHz | Case E | 23142-<2>-23368 |
| n260 | 120 kHz | Case D | 22995-<1>-23166 |
| | 240 kHz | Case E | 22996-<2>-23164 |
| n261 | 120 kHz | Case D | 22446-<1>-22492 |
| | 240 kHz | Case E | 22446-<2>-22490 |

In further related aspects, the term “cell search” may refer to a procedure for a UE to acquire time and frequency synchronization with a cell and to detect the Cell ID of the cell. For example, NR cell search may be based on PSS, SSS and PBCH demodulation reference signal (PBCH DMRS) located on the synchronization raster. In some examples, a PCell may always be associated to a CD-SSB located on the synchronization raster.

The techniques described in the present disclosure may improve power/energy savings at one or more cells by allowing them to enter a semi-active state corresponding to an energy-saving mode of operation. Moreover, the techniques described herein may improve power/energy savings at one or more UEs 115 by assisting them to detect more easily a cell in an active state which may be transmitting CD-SSBs.

In some aspects, the advantages provided by these techniques may also be relevant for massive MTC (mMTC) and NB-IoT use cases. For example, the techniques may be used by low power sensors communicating with gateways which may relay information to a gNB. Another example comprises multiple sensors collaborating with each other in sending information to a remote radio head (RRH), a gNB, or a smart meter, for example. Other examples may also comprise vehicle-to-vehicle (V2X), vehicle-to-infrastructure, or vehicle-to-everything scenarios. Other examples may comprise LTE-direct applications.

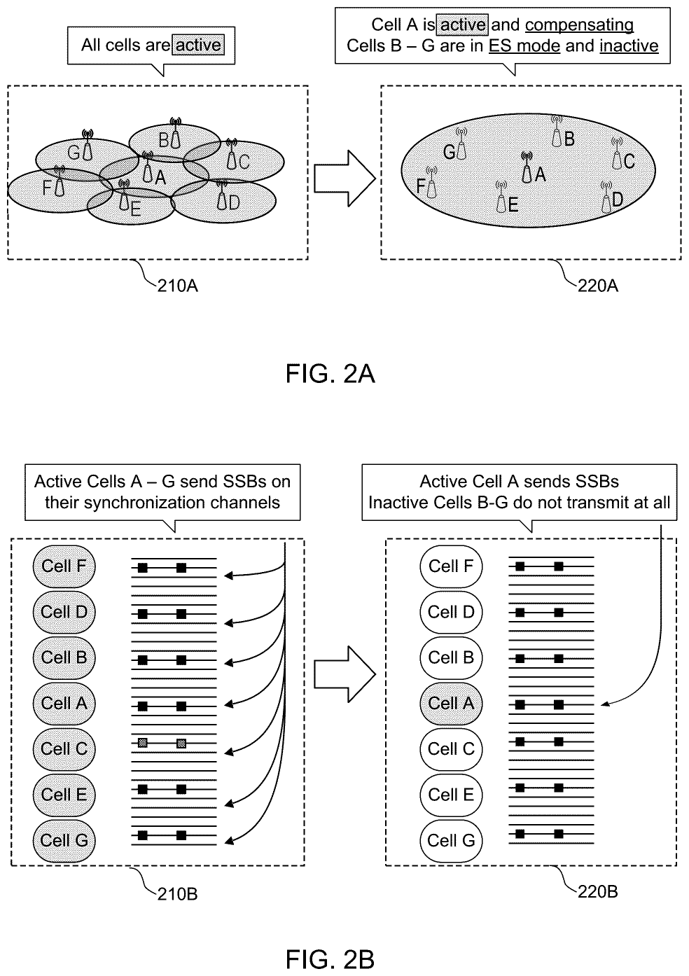

FIG. 2A and FIG. 2B illustrate different network configurations in which one or more cells send downlink signals, such as synchronization signals (e.g., periodic SSBs and/or CD-SSBs) in accordance with various aspects of the present disclosure.

More specifically, FIG. 2A illustrates on the left, at 210A, a network configuration in which all Cells A-G are active (i.e., in the active state). In their active states, Cells A-G may send downlink signals, such as synchronization signals (e.g., periodic SSBs and/or CD-SSBs), which may have similar transmission power levels and similarly sized coverage areas. Accordingly, in this example, the coverage areas are represented by ellipses of similar size. However, in other examples and deployment scenarios, the transmission power levels and the coverage areas may be different (e.g., from one another).

Correspondingly, FIG. 2B illustrates on the left, at 210B, an example of a possible representation on the frequency raster(s) of the downlink signals transmitted by the active Cells A-G illustrated in FIG. 2A, at 210A. In this example, each of the active Cells A-G transmits downlink signals, such as synchronization signals (e.g., periodic SSBs and/or CD-SSBs) on their respective synchronization channels/frequencies of the synchronization raster(s). Each of the rectangles may represent an instance of a downlink signal transmission (e.g., periodic SSBs and/or CD-SSBs) which may be associated with certain time and frequency resources and with a certain transmission power level. Schematically, the horizontal dimension may represent time (e.g., resources) and the vertical dimension may represent frequency (e.g., resources). The rectangles are drawn with different patterns to illustrate that the respective downlink signals may be distinguished from one another (e.g., a CD-SSB signal may carry a distinct cell identification).

FIG. 2A illustrates on the right, at 220A, a network configuration in which only Cell A is active (e.g., in the active state) while Cells B-G are in an energy-saving (ES) mode of operation and inactive (e.g., Cells B-G do not transmit any synchronization signals). In this example, Cell A is compensating for the inactive Cells B-G by sending with higher power, for example, synchronization signals (e.g., periodic SSBs and/or CD-SSBs), so that the coverage area of its transmissions may compensate or close, at least partially, the coverage gaps resulting from Cells B-G not transmitting.

Correspondingly, FIG. 2B shows on the right, at 220B, that only Cell A is actively transmitting downlink signals, such as synchronization signals (e.g., periodic SSBs and/or CD-SSBs) on its synchronization channel/frequency, while Cells B-G are in an energy-saving (ES) mode and inactive (i.e., in an inactive state), so that they do not transmit any downlink signals at all, or at least they do not transmit any synchronization signals (e.g., periodic SSBs and/or CD-SSBs). The empty rectangles shown at 220B for Cells B-G illustrate, graphically, that no signals are sent on the allocated time and frequency resources. Schematically, the horizontal dimension may represent time (e.g., resources) and the vertical dimension may represent frequency (e.g., resources).

In this example and other related examples and aspects, given that most of the synchronization channels/frequencies are idle when the Cells B-G are in an energy-saving (ES) mode of operation and inactive, a UE may have difficulty detecting the synchronization channel on which the only active Cell A is transmitting, although the UE may be within the coverage area of the active Cell A, which may lead to increased latency and increased energy/power consumption at the UE. In accordance with various aspects of the present disclosure, the synchronization channel/frequency of a cell may also be referred to, interchangeably, as a synchronization raster, since the synchronization channels/frequencies of different cells may be on different synchronization rasters. In related aspects, only one (or only a few) synchronization channel(s), may be active on a certain synchronization raster. In some aspects, a synchronization raster may be considered to represent the set of frequencies known to the UE on which the UE would search to find synchronization signals (e.g., periodic SSBs and/or CD-SSBs). Those cells that transmit on any of the frequencies of the synchronization raster will be discoverable by the UE. Not all cells have to use the same frequency, but if that cell frequency is not that of a synchronization raster, the UE needs assistance to be able to discover it or else it would not.

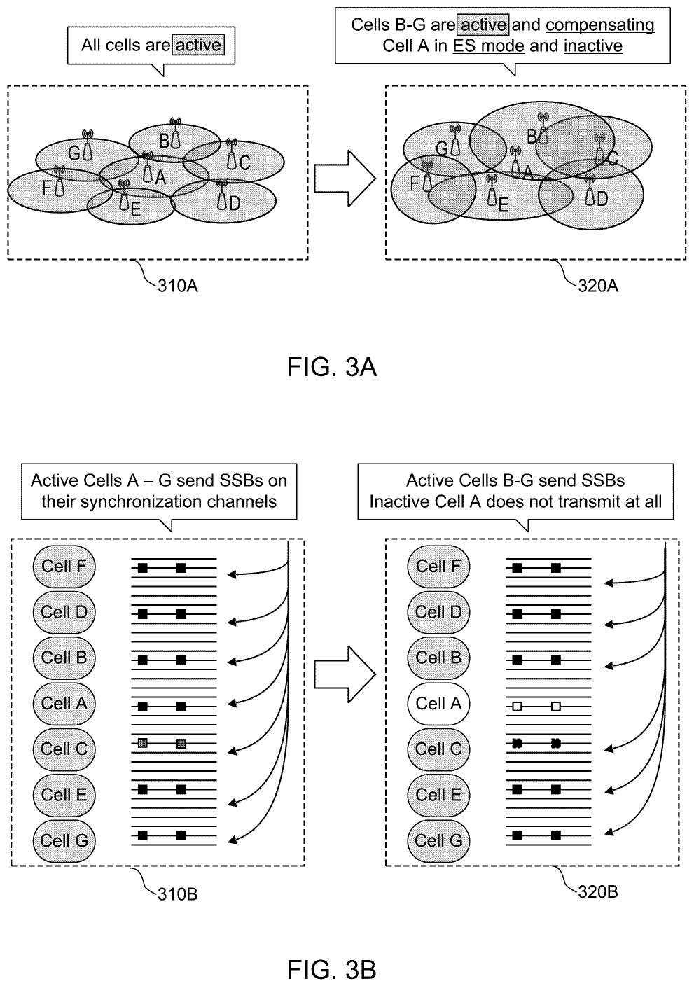

FIG. 3A and FIG. 3B illustrate different network configurations in which one or more cells send downlink signals, such as synchronization signals (e.g., periodic SSBs and/or CD-SSBs) in accordance with various aspects of the present disclosure.

More specifically, FIG. 3A illustrates on the left, at 310A, a network configuration in which all Cells A-G are active (e.g., in the active state). In their active states, Cells A-G may send downlink signals, such as synchronization signals (e.g., periodic SSBs and/or CD-SSBs), which may have similar transmission power levels and similarly sized coverage areas. Accordingly, in this example, the coverage areas are represented by ellipses of similar size. However, in other examples and deployment scenarios, the transmission power levels and the coverage areas may be different (e.g., from one another).

Correspondingly, FIG. 3B illustrates on the left, at 310B, an example of a possible representation on the frequency raster(s) of the downlink signals transmitted by the active Cells A-G illustrated in FIG. 3A, at 310A. In this example, each of the active Cells A-G transmits downlink signals, such as synchronization signals (e.g., periodic SSBs and/or CD-SSBs) on their respective synchronization channels/frequencies of the synchronization raster(s). Each of the rectangles may represent an instance of a downlink signal transmission (e.g., periodic SSBs and/or CD-SSBs) which may be associated with certain time and frequency resources and with a certain transmission power level. Schematically, the horizontal dimension may represent time (e.g., resources) and the vertical dimension may represent frequency (e.g., resources). The rectangles are drawn with different patterns to illustrate that the respective downlink signals may be distinguished from one another (e.g., a CD-SSB signal may carry a distinct cell identification). The network and signaling configurations shown in FIG. 3A, at 310A, and in FIG. 3B, at 310B, correspond to those shown in FIG. 2A, at 210A, and FIG. 2B, at 210B (e.g., when all cells are active).

FIG. 3A illustrates on the right, at 320A, a network configuration in which only Cells B-G are active (e.g., in the active state) while Cell A is in an energy-saving (ES) mode of operation and inactive (e.g., Cell A does not transmit any synchronization signals). In this example, Cells B-G are compensating for the inactive Cell A by sending with higher power, for example, synchronization signals (e.g., periodic SSBs and/or CD-SSBs). In this example, the combined coverage areas of the transmissions from active Cells B-G may compensate or close, at least partially, the coverage gap resulting from inactive Cell A not transmitting.

Correspondingly, FIG. 3B shows on the right, at 320B, that Cells B-G are actively transmitting downlink signals, such as synchronization signals (e.g., periodic SSBs and/or CD-SSBs) on their respective synchronization channels/frequencies, while Cell A is in an energy-saving (ES) mode and inactive (i.e., in an inactive state), so that Cell A does not transmit any downlink signals at all, or at least does not transmit any synchronization signals (e.g., periodic SSBs and/or CD-SSBs). The empty rectangles shown at 320B for Cell A illustrate, graphically, that no signals are sent on the allocated time and frequency resources. Schematically, the horizontal dimension may represent time (e.g., resources) and the vertical dimension may represent frequency (e.g., resources).

In this example, as well as other related examples, given that the synchronization channel/frequency corresponding to Cell A is idle, a UE may have difficulty detecting the synchronization channels of the active Cells B-G, which may lead to increased latency and increased power consumption at the UE. In accordance with various aspects of the present disclosure, the synchronization channel/frequency of a cell may also be referred to, interchangeably, as a synchronization raster, since the synchronization channels/frequencies of different cells may be on different synchronization rasters. In related aspects, only one (or only a few) synchronization channel(s), may be active on a certain synchronization raster. In some aspects, a synchronization raster may be considered to represent the set of frequencies known to the UE on which the UE would search to find synchronization signals (e.g., periodic SSBs and/or CD-SSBs). Those cells that transmit on any of the frequencies of the synchronization raster will be discoverable by the UE. Not all cells have to use the same frequency, but if that cell frequency is not that of a synchronization raster, the UE needs assistance to be able to discover it or else it would not.

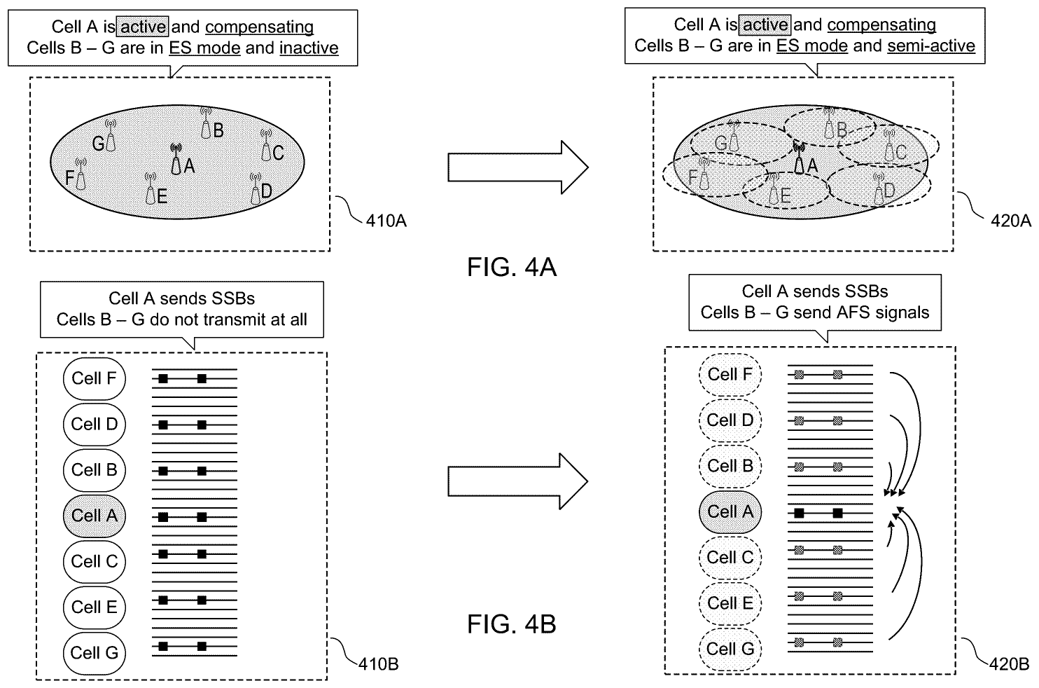

FIG. 4A illustrates on the left, at 410A, a network configuration where Cells B-G are in energy-saving (ES) mode and inactive (i.e., not sending any signals), while only Cell A is active and compensating (for coverage) by sending with higher power, and on the right, at 420A, a configuration where Cell A is still active and compensating, while Cells B-G are in an energy-saving (ES) mode and semi-active. For example, semi-active Cells B-G may transmit an assisted frequency scan (AFS) signal, which in some aspects may be simpler and more efficient than SSBs/CD-SSBs.

In some aspects, the AFS signal may be transmitted periodically, for example, with a predefined or configurable periodicity. In the context of this disclosure, the AFS signal may also be referred to as a downlink signal, a downlink reference signal (RS), or an AFS reference signal (AFS-RS). The AFS-RS may span only one or two symbols (e.g., OFDM symbols), whereas the SSB spans four symbols. Accordingly, the AFS-RS burst can be much more compact than the SSB burst, which allows energy/power savings at the semi-active cells. In addition, or alternatively, the AFS-RS may support a large range of indices, may also support indication of multiple raster candidates and inter-band raster indication, and may provide more information about active cells (e.g., cell ID, SSB configuration, periodicity). Some of the design options for carrying the information may comprise sequence scrambling ID of AFS-RS, payload of a broadcast channel (which may be sent on demand, triggered by an uplink signal sent by the UE), and/or repurpose master information block (MIB) content.

FIG. 4B illustrates on the left, at 410B, the corresponding representation on the synchronization raster(s) of the transmission configuration shown in FIG. 4a, at 410A, and on the right, at 420B, the representation on the frequency raster(s) of the transmission configuration shown in FIG. 4A, at 420A. Schematically, the horizontal dimension may represent time (e.g., resources) and the vertical dimension may represent frequency (e.g., resources). In particular, FIG. 4B illustrates at 420 B, that a UE detecting a synchronization signal from one of the semi-active Cells B-G may determine from the AFS signal transmitted by the semi-active cell the synchronization channel of the active Cell A. This saves the UE the task of (time and) energy/power-consuming (exhaustive) search on the synchronization raster(s) for the synchronization channel of active Cell A.

In some aspects, semi-active Cells B-G consume more power than in an inactive state, for example, above a first energy/power threshold, P_{TH1}, but less power than in the active state, for example, below a second energy/power threshold, P_{TH1}. The latency of semi-active Cells B-G may also be (e.g., significantly) lower than if they were in the inactive state. For example, semi-active Cells B-G may transition more quickly to the active state, if needed, than if they were in the inactive state. In addition, semi-active Cells B-G may assist a UE in the (extended) coverage area of active Cell A to find the synchronization frequency on which active Cell A transmits synchronization signals (e.g., periodic SSBs and/or CD-SSBs), as illustrated in FIG. 4B on the right, at 420B. Therefore, the semi-active state(s) of a cell may enable energy/power savings both at the cell(s)/RAN level and at the UE level.

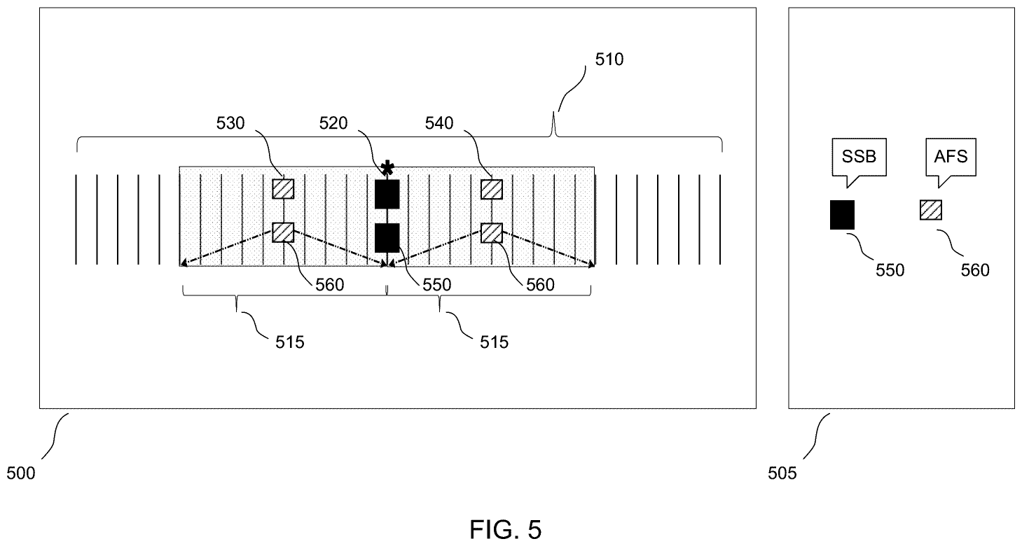

FIG. 5 illustrates in diagram 500 an example of a synchronization/frequency raster 510. However, a plurality of synchronization/frequency rasters may be commonly denoted by numeral 510 in FIG. 5. Each vertical line may represent the time dimension/axis associated with a specific synchronization/frequency channel, for example, channels denoted by numerals 520, 530, 540 on the raster 510. In FIG. 5, the synchronization/frequency raster 510 is rotated by 90° with respect to the synchronization/frequency rasters illustrated in FIG. 2B, at 210B and 220B, FIG. 3B, at 310B and 320B, and FIG. 4B, at 410B and 420B.

In some aspects, as explained in connection with FIG. 1 and Tables 2 and 3, the term “synchronization raster” may commonly refer to the frequency positions of the synchronization signal block (SSB), that can be used by the UE for system acquisition when explicit signaling of the SSB position is not present. A global synchronization raster may be defined for all frequencies. For example, in a wireless communication system such as NR, the frequency position of the SSB may be defined as SS_{REF} with corresponding Global Synchronization Channel Number (GSCN). The synchronization raster and the subcarrier spacing of the SSB may be defined separately for each operating band, which may therefore be regarded as a plurality of different synchronization rasters (e.g., the operating bands may correspond to those defined in Table 2, and the synchronization raster for each operating band may be defined as indicated in Table 3). The term “cell search” may refer to a procedure for a UE to acquire time and frequency synchronization with a cell and to detect the Cell ID of the cell. For example, NR cell search may be based on PSS, SSS and PBCH demodulation reference signal (PBCH DMRS) located on the synchronization raster. In some examples, a PCell may always be associated to a CD-SSB located on the synchronization raster.

In the context of this disclosure, the terms “channel”, “synchronization channel”, “frequency channel”, “synchronization frequency”, “synchronization frequency channel” may be used interchangeably. Also the terms “raster”, “frequency raster”, “synchronization raster” may be used interchangeably. In addition, the terms “range”, “frequency range”, “channel range” may be used interchangeably. In some aspects, a “channel” on the “synchronization raster” on which an active cell is sending synchronization signals may be referred to as a “synchronization channel”, while a “channel” on the “synchronization raster” on which a semi-active cell is sending AFS signals may be referred to simply as a “frequency channel”.

FIG. 5 illustrates synchronization/frequency channel 520 of an active cell which may transmit downlink signals, such as synchronization signals 550 (e.g., periodic SSBs and/or CD-SSBs). For example, the active cell may be Cell A which may transmit periodic SSBs/CD-SSBs with higher power to compensate for the coverage gaps left by the semi-active Cells B-G operating in energy-saving mode, as illustrated in FIG. 4A, at 420A.

FIG. 5 further illustrates in diagram 500 transmissions from two semi-active cells on frequency channels 530 and 540 of downlink signals 560, such as assistance frequency scan (AFS) signals, for assisting at least one UE 115 to detect the synchronization signals 550 transmitted by active Cell A on synchronization channel 520. The AFS signals 560 may take fewer resources than the synchronization signals 550 (e.g., one or two symbols), and may convey sufficient information for the UE to identify the synchronization channel 520 of the active Cell A. For example, the AFS signal may be configured to indicate that the synchronization channel 520 is within a range 515 on the raster 510. The range 515 may be expressed in any suitable manner, such as a number of channels. In some aspects, the range 515 may be signaled implicitly (e.g., the range may be pre-configured), or explicitly (e.g., the range may be specified as a parameter, or information element (IE), of the AFS signal).

For example, the two semi-active cells transmitting AFS signals on frequency channels 530 and 540 may correspond to the semi-active Cells B and C shown in FIG. 4A, on the right, at 420. One or more UEs 115 (not shown in FIG. 4A) may be found in the overlapping coverage areas of semi-active cells B and C, which are marked with dotted line to illustrate that the coverage corresponds only to transmissions of AFS signals, but not synchronization signals. In contrast, the coverage area of active Cell A, compensating for semi-active Cells B-G is marked with solid line to illustrate that the coverage corresponds to transmissions of synchronization signals (e.g., periodic SSBs/CD-SSBs). A particular UE 115 in the overlapping coverages areas of semi-active Cells B and C may receive one or more of the (e.g., periodic) AFS signals 560 transmitted by the semi-active Cell B on frequency channel 530 and by the semi-active Cell C on frequency channel 540 (e.g., depending on the frequency channels the UE 115 is configured to search). The UE 115 may determine from the one or more AFS signals 560 (e.g., based at least in part on the range 515), the specific synchronization channel 520 on which active Cell A transmits the synchronization signals 550 (e.g, periodic SSBs/CD-SSBs). Thereafter, the UE 115 may tune its receiver to the synchronization channel 520 and acquire the signals 550 from the active Cell A for system access. In some aspects, Cells A-G may correspond to any of the cells 105 shown in FIG. 1.

Accordingly, a UE 115 receiving one of the AFS signals 560 may learn more easily about the presence of the active cell and the synchronization channel 520 on which the active cell sends the synchronization signals 550 (e.g., periodic SSBs and/or CD-SSBs). As a result, in addition to the network energy/power saving resulting from the at least two semi-active cells 105 operating in an energy saving (ES) mode of operation instead of an energy-intensive mode of operation corresponding to an active state, the UE 115 may also save power which would otherwise be wasted on searching all synchronization/frequency channels on the raster(s) 510 until the UE 115 detects the synchronization channel 520 on which the synchronization signals 550 are sent by the active cell 105. When the UE 115 detects the CD-SSBs transmitted by the active cell 105, it may acquire the primary synchronization signal (PSS) and secondary synchronization signal (SSS) in order to access the active cell 105.

Finally, FIG. 5 illustrates in diagram 505 a legend for the signals shown in diagram 500. For example, an instance of a synchronization signal block (SSB) signal (e.g., a cell defining SSB (CD-SSB) signal), is represented by a black rectangle 550. Correspondingly, an instance of an AFS signal is represented by a hatched rectangle 560. The SSB signal 550 is shown in an elongated representation on the vertical/time axis to illustrate that it may occupy more time resources (e.g., four OFDM symbols) than the AFS signal 560 (e.g., one or two OFDM symbols). However, the figures are not drawn to scale and the different dimensions may show qualitatively, but not quantitatively, the difference in the resources occupied by the SSB and, respectively, AFS signals.

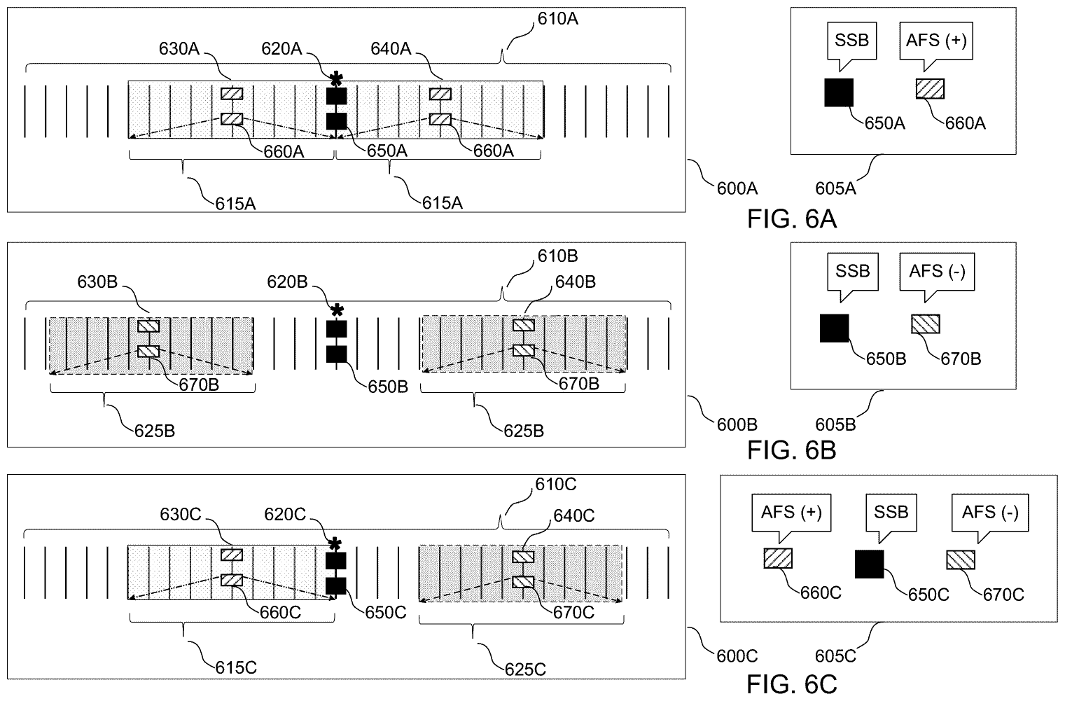

FIGS. 6A-6C illustrate various configurations for sending various types of AFS signals, which may represent specific examples of the AFS signals 560 shown in FIG. 5.

For example, FIG. 6A illustrates in diagram 600A an active cell (e.g., the active Cell A in FIG. 4A and/or FIG. 4B, which may correspond to one of the cells 115 in FIG. 1) which is sending one or more downlink synchronization signals 650A (e.g., periodic SSB and/or CD-SSBs) on the synchronization channel 620A and two semi-active cells (e.g., one of the semi-active Cells B-G in FIG. 4A and/or FIG. 4B, which may correspond to one of the cells 115 in FIG. 1) which are sending on frequency channels 630A and, respectively, 640A one or more “positive” AFS signals 660A, namely AFS signals that indicate that there is a synchronization channel/raster 620A of an active cell within some frequency range 615A relative to frequency channel 630A and/or frequency channel 640A on the synchronization/frequency raster 610A. The frequency range 615A may be expressed in any suitable manner, such as a number of channels. In some aspects, the frequency range 615A may be signaled implicitly (e.g., the range may be pre-configured), or explicitly (e.g., the range may be specified as a parameter, or information element (IE), of the “positive” AFS signals 660A). In some examples, the range 615A relative to the channel 630A may be different from the range 615A relative to the channel 640A. In other examples, the ranges 615A may be identical.

FIG. 6A further illustrates in diagram 605A a legend for the signals shown in diagram 600A. In this example, an instance of a synchronization signal block (SSB) signal (e.g., a cell defining SSB (CD-SSB) signal), is represented by a black rectangle 650A. Correspondingly, an instance of a “positive” AFS signal (which may be denoted as “AFS (+)”) is represented by a hatched rectangle 660A. The SSB signal 650A is shown in an elongated representation on the vertical/time axis to illustrate that it may occupy more resources in the time domain (e.g., four OFDM symbols) compared to the “positive” AFS signal 660A (e.g., one or two OFDM symbols). However, the figures are not drawn to scale and the different dimensions may show qualitatively, but not quantitatively, any differences in the resources occupied by the SSB and, respectively, AFS signals.

In another example, FIG. 6B illustrates in diagram 600B an active cell sending one or more downlink synchronization signals 650B (e.g., periodic SSB and/or CD-SSBs) on synchronization channel 620B and two semi-active cells sending on frequency channels 630B and, respectively, 640B one or more “negative” AFS signals 670B, namely, AFS signals that indicate that there is not any synchronization channel/raster 620B of an active cell within some frequency ranges 625B relative to frequency channel 630B and/or frequency channel 640B on the synchronization/frequency raster 610B. The frequency ranges 625B may be expressed in any suitable manner, such as a number of channels. In some aspects, the frequency ranges 625B may be signaled implicitly (e.g., the range may be pre-configured), or explicitly (e.g., the range may be specified as a parameter, or information element (IE), of the “negative” AFS signals 670B). In some examples, the frequency range 625B relative to frequency channel 630B may be different from the frequency range 625B relative to frequency channel 640B. In other examples, the frequency ranges 625B may be identical.

FIG. 6B further illustrates in diagram 605B a legend for the signals shown in diagram 600B. In this example, an instance of a synchronization signal block (SSB) signal (e.g., a cell defining SSB (CD-SSB) signal), is represented as a black rectangle 650B. Correspondingly, an instance of a “negative” assisted frequency scan (AFS) signal (which may be denoted as “AFS (−)”) is represented as a hatched rectangle 670B, wherein the hatching pattern is different from that of the “positive” AFS signal 660A. The SSB signal 650B is shown in an elongated representation on the vertical/time axis to illustrate that it may occupy more resources in the time domain (e.g., four OFDM symbols) compared to the “negative” AFS signal 670B (e.g., one or two OFDM symbols). However, the figures are not drawn to scale and the different dimensions may show qualitatively, but not quantitatively, any differences in the resources occupied by the SSB and, respectively, AFS signals.

In a further example, FIG. 6C illustrates in diagram 600C a combination of “positive” AFS signals 660C and “negative” AFS signals 670C. An active cell is sending one or more downlink synchronization signals 650C (e.g., periodic SSB and/or CD-SSBs) on the synchronization channel 620C of the synchronization/frequency raster 610C. A semi-active cell is sending one or more “positive” AFS signals 660C on the frequency channel 630C, and another semi-active cell is sending one or more “negative” AFS signals 670C on the frequency channel 640C of the raster 610C. The “positive” AFS signals 660C indicate that there is a synchronization channel 620C of an active cell within a first range 615C relative to the frequency channel 630C, whereas the “negative” AFS signals 670C indicate that there is not any synchronization channel, such as channel 620C, of an active cell within a second range 625C relative to the frequency channel 640C. The ranges 615C and 625C may be expressed in any suitable manner, such as a number of channels. In some aspects, the ranges 615C and 625C may be signaled implicitly (e.g., the ranges may be pre-configured), or explicitly (e.g., the ranges may be specified as a parameter, or information element (IE), of the respective AFS signals 660C and 670C), and various combinations are contemplated within the scope of the present disclosure. In some examples, the range 615C may be the same as the range 625C. In other examples, the ranges may be different from one another.

FIG. 6C further illustrates in diagram 605C a legend for the signals shown in diagram 600C. In this example, an instance of a synchronization signal block (SSB) signal (e.g., a cell defining SSB (CD-SSB) signal), is represented as a black rectangle 650C. An instance of a “positive” AFS signal (which may be denoted as “AFS (+)”) is represented as a hatched rectangle 660C. Similarly, an instance of a “negative” AFS signal (which may be denoted as “AFS (−)”) is represented as a differently hatched rectangle 670C. The SSB signal 650C is shown in an elongated representation on the vertical/time axis to illustrate that it may occupy more resources in the time domain (e.g., four OFDM symbols) compared to the “positive” AFS signal 660C (e.g., one or two OFDM symbols) and/or the “negative” AFS signal 670C (e.g., one or two OFDM symbols). However, the figures are not drawn to scale and the different dimensions may show qualitatively, but not quantitatively, any differences in the resources occupied by the SSB and, respectively, AFS signals.

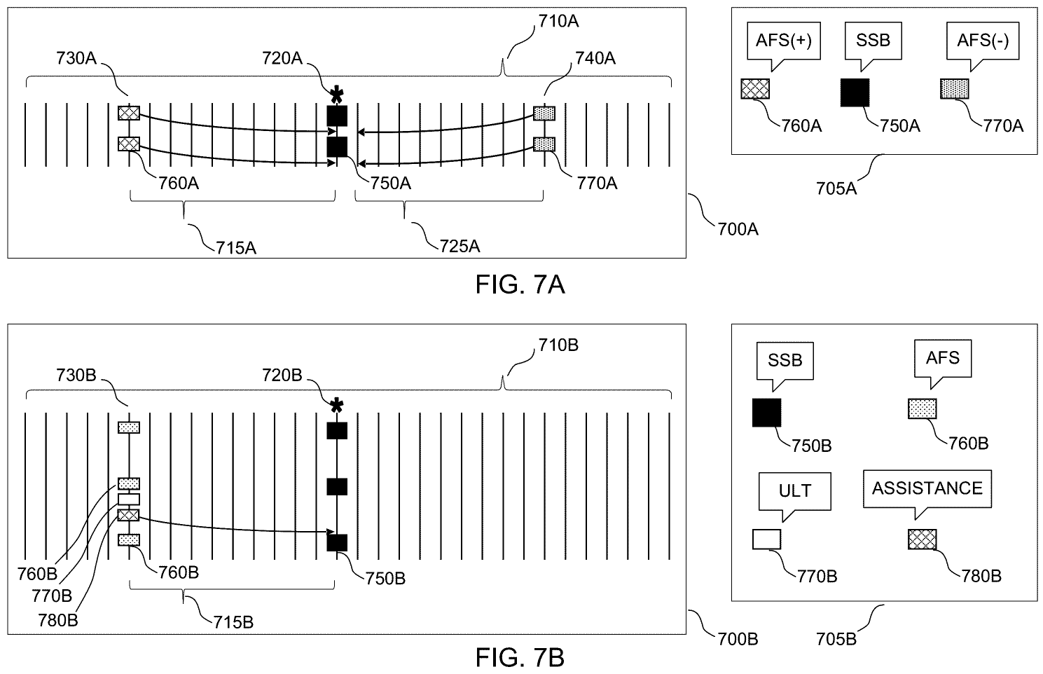

FIGS. 7A-7B illustrate further types of AFS signals. For example, FIG. 7A illustrates in the diagram 700A a raster 710A with an active cell sending synchronization signals 750A (e.g., SSBs and/or CD-SSBs) on the synchronization channel 720A and two semi-active cells sending AFS signals 760A and 770A on frequency channels 730A and respectively, 740A, of the raster 710A. The AFS signals 760A may be regarded as explicit “positive” AFS signals, e.g., AFS signals that explicitly indicate a frequency/channel offset 715A (or frequency/channel range 715A), relative to the frequency channel 730A, to the synchronization channel 720A on the raster 710 of the active cell sending synchronization signals 750A (e.g., CD-SSB and/or CD-SSBs). The AFS signals 770A may be regarded as explicit “negative” AFS signals, e.g., AFS signals that explicitly indicate a frequency/channel offset 725A (or frequency/channel range 725A), relative to the frequency channel 740A, where no synchronization channel of an active cell can be found on the raster 710A. The vertical lines may represent the time axis/dimension, so that FIG. 7A shows the two semi-active cells sending the respective AFS signals 760A and 770A with the same period as the synchronization signals 750A sent by the active cell. However, the AFS signals 760A and 770A may be sent with a different periodicity from the synchronization signals 750A. In the context of this disclosure, the term “period” may refer to a portion of time determined by a recurring phenomenon (e.g., transmission of AFS signals), and the term “periodicity” may refer to the quality, state, or fact of events being regularly recurrent or having “periods”. In some aspects, the terms “period” and “periodicity” may be used interchangeably.

Although in the diagram 700A shown in FIG. 7A, the AFS signals 760A and 770A appear to be sent at the same time instants (e.g., synchronously) with the synchronization signals 750A, in other examples this does not have to be the case. Alternatively, the AFS signals 760A and 770A may be sent at different times (e.g., shifted in time) relative to the synchronization signals 750A, with the same periodicity as the synchronization signals 750A or with different periodicities (e.g., from the synchronization signals 750A and from one another). Moreover, these properties may be either pre-defined or configurable (e.g., by the network operator). FIG. 7A shows in the diagram 705A a legend with the signals illustrated in the diagram 700A. Specifically, the diagram 705A shows the synchronization signals 750A (e.g., SSBs and/or CD-SSBs) as a black rectangle. Both the explicit “positive” AFS signals 760A, which are denoted as “AFS (+)”, and the explicit “negative” AFS signals 770A, which are denoted as “AFS (−)”, are represented by hashed rectangles, with different patterns.

FIG. 7B illustrates in the diagram 700B an example of a semi-active cell sending AFS signals 760B on the frequency channel 730B of the raster 710B. In this example, the AFS signals 760B which may be accompanied by further assistance information signals 780B, which may be sent either periodically or on demand. Specifically, the further assistance information signals 780B may comprise more granular information such as the exact location of synchronization/frequency channels 720B (and/or synchronization rasters 710B) with (or without) active cells sending synchronization signals 750B (e.g., SSBs and/or CD-SSBs), the periodicity of the synchronization signals, the cell IDs of the active cells, et cetera.

In some aspects, according to a first alternative (Alt1), the further assistance information 780B may be provided in a channel or with a reference signal (RS) associated with the AFS signals 760B and it may have the same or larger period than the AFS signals 760B (e.g., the further assistance information 780B may be sent either as frequently or less frequently than the AFS signals 760B). In other aspects, according to a second alternative (Alt2), which is illustrated in the diagram 700B of FIG. 7B, a semi-active cell may periodically send AFS signals 760B containing minimum information. A UE 115 may receive an AFS signal 760B and, in response thereto, the UE 115 may send an uplink trigger (ULT) signal 770B requesting further assistance information 780B. The semi-active cell receiving the ULT signal 770B may provide the further assistance information signal 780B in response to the request. The AFS signal may also be referred to as the AFS reference signal (AFS-RS).

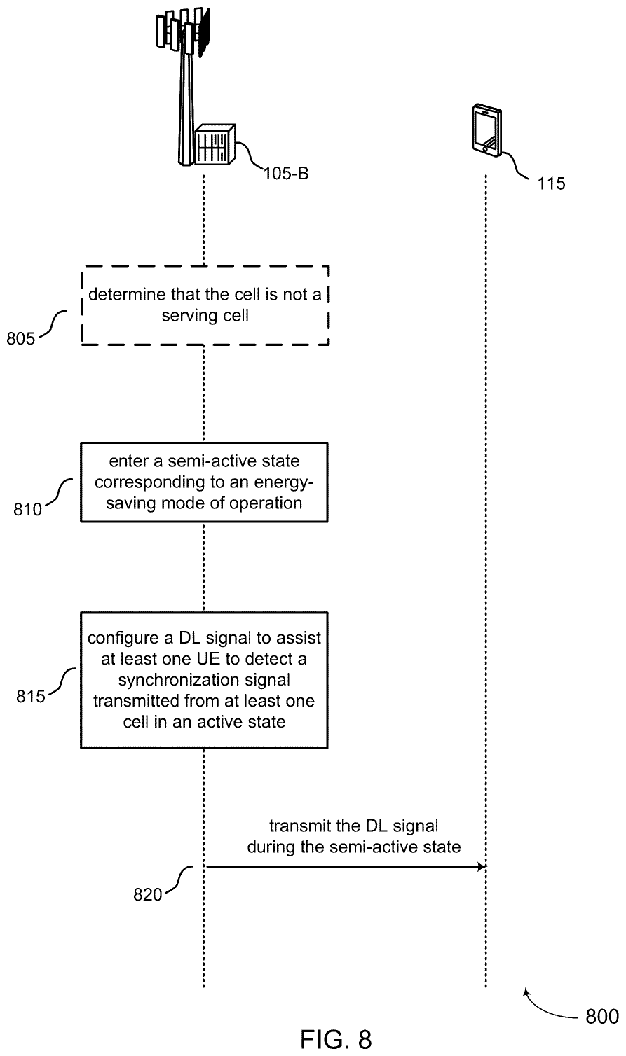

It is understood that the examples presented with reference to the FIGS. 1, 2A-2B, 3A-3B, 4A-4B, 5, 6A-6C, 7A-7B represent only some aspects of the present disclosure. These and other related aspects will be further discussed with reference to FIGS. 8-20.

FIG. 8 shows a diagram 800 illustrating an example of wireless communication between a cell 105-B and a UE 115 in accordance with some aspects of the present disclosure. The cell may be called a base station, a network node, a gNB, etc. Optionally, at 805, the cell may determine that it is not a serving cell for any UE. At 810 the cell may enter a semi-active state corresponding to an energy saving (ES) mode of operation. At 815 the cell may configure a DL signal to assist at least one UE 115 to detect a synchronization signal, e.g., a CD-SSB, transmitted by at least one other cell in an active state. The DL signal may be an AFS signal as shown in one of preceding figures (e.g., FIGS. 6A-6C and/or FIGS. 7A-7B). At 820, the cell may transmit the DL signal during the semi-active state and the UE 115 may receive the DL signal. Although not shown in FIG. 8, the UE 115 may learn from the DL signal the synchronization raster of another cell in an active state sending a CD-SSB.

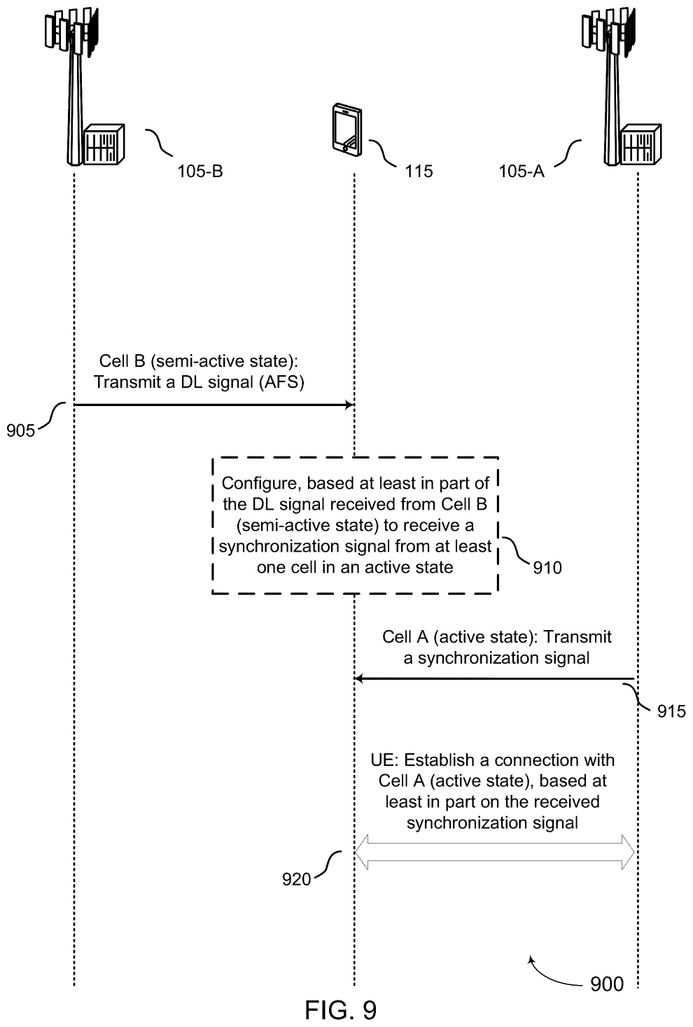

FIG. 9 shows a diagram 900 illustrating another example of wireless communication involving a UE 115 and two cells 105-B (Cell B) and 105-A (Cell A) in accordance with some aspects of the present disclosure. Cell B may be in a semi-active state corresponding to an energy-saving mode of operation and Cell A may be in an active state corresponding to an energy-intensive mode of operation, e.g., a mode in which the cell is fully operational. The terms energy and power are used interchangeably in the context of the present disclosure. At 905, Cell B may transmit a DL signal, e.g., an AFS signal as illustrated in one or more of the preceding figures (e.g., FIGS. 6A-6C and/or FIGS. 7A-7B), to assist the at least one UE 115 to detect a synchronization signal, e.g., a CD-SSB, transmitted by at least one other cell in an active state. The at least one other cell in an active state may be Cell A. The UE 115 may receive the DL signal and may configure at 905, based at least in part on the received DL signal, its transceiver to receive a synchronization signal transmitted from at least one cell in an active state. At 915, Cell A in an active state may transmit a synchronization signal, e.g., a CD-SSB, which may be received by the UE 115. At 920 the UE 115 and Cell A may establish a connection based at least in part on the synchronization signal received by the UE.

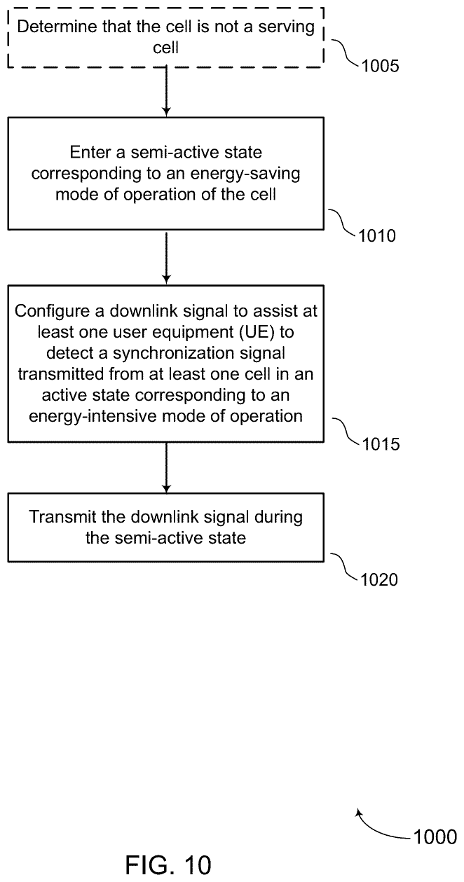

FIG. 10 shows a flowchart illustrating a method 1000 by (or at) a cell (e.g., base station, network node, gNB, etc.) in accordance with a first (cell-related) aspect of the present disclosure. Optionally, at 1005, a cell (e.g., cell 105-B shown in FIG. 8 and/or FIG. 9) may determine that it is not a serving cell. For example, the cell may determine that it has not served any UE for a certain period of time, wherein the period of time may be predetermined (e.g., “hardwired” in the system and possibly defined in a corresponding wireless communication standard) or adjustable, i.e., configurable (e.g., by a network entity). One particular example of a predetermined period of time may be “zero” time units, e.g., “zero” milliseconds (ms). In other words, the cell may determine (i.e., establish) that it is not a serving cell, as soon as there is no UE left which is served by the cell (e.g., after a handover of the last or single UE to another cell). In other examples, the period of time may be a non-negative integer of time units greater than zero (e.g., 10 or 20 ms). In some aspects, a predetermined period of time has the benefit of reducing the complexity of implementation and deployment (e.g., minimizing signaling within the network, i.e., from the network entity configuring the cell). In related aspects, an adjustable period of time has the benefit of improving the flexibility of implementation and deployment (e.g., in terms of the tradeoff between network latency and energy savings).

In still other related aspects, the period of time may be adjusted, i.e., configured, by the cell itself without participation of another network entity (e.g., based at least in part on network load, one or more statistics associated with the cell, such as the number of UEs served by the cell, the time intervals during which the cell acted as a serving cell, etc.). The configurable period of time may be adjusted by local optimization algorithms (e.g., at the cell level or routing area level) and/or global optimization algorithms (e.g., at the network level).

The optimization algorithms may employ supervised and/or unsupervised machine learning (e.g., using artificial neural networks), and the optimization criteria may comprise network latency and energy savings. As mentioned previously, both the network (i.e., cells, network nodes, base stations, gNBs) and the UEs seeking to access the network may benefit from the techniques for energy savings in accordance with the present disclosure. Therefore, the optimization criterion of “energy savings” may observe the best tradeoff between network energy savings and UE energy savings. For example, the network may save energy in a certain service area by having only one cell in the active state and all the other cells in the semi-active state. However, a UE may save energy (i.e., battery power) for uplink transmissions by having an active cell in the immediate neighborhood, so that the transmission power for accessing and communicating with the active cell is minimized Hence, from the perspective of the UE power saving, several active cells offering multiple options for communicating in the service area may be more beneficial than a single active cell. These and other aspects may drive the optimization of the adjustable period of time serving as a threshold for determining (i.e., declaring) that a cell is not a serving cell.

At 1010, the cell may enter a semi-active state corresponding to an energy saving (ES) mode of operation of the cell. Optionally, the cell may enter the semi-active state, at 1010, based at least in part on determining, at 1005, that the cell is not a serving cell. Additionally, or alternatively, the cell may enter the semi-active state based at least in part on receiving a prior message (i.e., a trigger signal, not shown in FIG. 10) from a network entity. In other words, the cell may enter the semi-active state based at least in part on: (a) determining that the cell is not a serving cell (e.g., the cell has not served any UEs for a certain period of time), and/or (b) receiving a trigger signal from a network entity. Other triggers causing the cell to enter the semi-active state fall within the scope of the disclosure.

At 1015, the cell may configure a downlink signal to assist at least one UE (e.g., UE 115 shown in FIG. 8 and/or FIG. 9) to detect a synchronization signal (e.g., a CD-SSB) transmitted from at least one cell in an active state corresponding to an energy intensive mode of operation (e.g., cell 105-A shown in FIG. 9). As described previously, a cell in the active state may be regarded as fully functional, i.e., all the functions of the cell are available causing the highest power consumption. Both the downlink signal transmitted by the cell in the semi-active state and the synchronization signal transmitted by the at least one cell in the active state may be periodic signals having the same or different periods (also referred to interchangeably as periodicities). In some aspects, the period of transmission of the downlink signal is higher than the period of transmission of the synchronization signal, i.e., the frequency of transmission of the downlink signal is lower than the frequency of transmission of the synchronization signal causing the cell in the semi-active state to save more energy than the cell in the active state. For example, the frequency of transmission of the synchronization signal by the at least one cell in the active state may be a non-negative integer multiple (greater than zero) of the frequency of transmission of the downlink signal by the cell in the semi-active state. Moreover, the two periodic signals may be time shifted relative to one another. The time shift may be sufficient to allow a UE receiving, decoding and interpreting the downlink signal to tune into the frequency channel on which the next occurrence of the synchronization signal is transmitted by the cell in the active state.

Finally, at 1020, the cell may transmit the downlink signal. Reciprocally, a UE within the radio coverage of the cell may receive the downlink signal and derive therefrom the information for detecting a synchronization signal from at least one other cell in the active state. Some steps of the method 1000 may represent optional aspects of the disclosure. For example, to emphasize the optional aspect, step 1005 is shown in a box with dashed line.

The downlink signal may be an AFS signal as illustrated in one or more of the preceding figures (e.g., FIGS. 6A-6C and/or FIGS. 7A-7B). The cell in the semi-active state and the cell in the active state may belong to the same network node (e.g., base station, gNB, etc.). Alternatively, they may belong to different network nodes as illustrated, for example, in FIG. 9, where Cell B (105-B) represents the cell in the semi-active state and Cell A (105-A) represents the cell in the active state. Moreover, in related aspects there may be a first plurality of cells in the semi-active state and a second plurality of cells in the active state exchanging signaling with the same UE or with different UEs.

In a second aspect related to the first (cell-related) aspect described above, the downlink signal may be configured to indicate implicitly at least one frequency channel corresponding to the at least one cell in the active state. In a third aspect related to the second aspect, the downlink signal may be configured to indicate implicitly that the at least one frequency channel is within a pre-configured range on a frequency raster, e.g., relative to a frequency channel corresponding to the cell in the semi-active state. In a fourth aspect related to the second aspect, the downlink signal may be configured to indicate implicitly that the at least one frequency channel is not within a pre-configured range on a frequency raster, e.g., relative to a frequency channel corresponding to the cell in the semi-active state.

In a fifth aspect related to the first aspect, the downlink signal may be configured to indicate explicitly at least one frequency channel corresponding to the at least one cell in the active state. In a sixth aspect related to the fifth aspect, the downlink signal may be configured to indicate explicitly that the at least one frequency channel is within a specified range on the frequency raster, e.g., relative to a frequency channel corresponding to the cell in the semi-active state. In a seventh aspect related to the fifth aspect, the downlink signal may be configured to indicate explicitly that the at least one frequency channel is not within a specified range on the frequency raster, e.g., relative to a frequency channel corresponding to the cell in the semi-active state.

In an eighth aspect related to any of the previous aspects, the cell in a semi-active state (e.g., cell 105-B in FIG. 8 and/or FIG. 9) may receive an uplink request for additional assistance information from the at least one UE (e.g., UE 115 in FIG. 8 and/or FIG. 9). In response thereto, the cell in a semi-active state may configure an additional downlink signal to provide the additional assistance information based at least in part on the uplink request. Finally, the cell in a semi-active state may transmit the additional downlink signal to the UE.

In a ninth aspect related to one or more of the previous aspects, configuring the downlink signal may comprise configuring the downlink signal according to a default configuration. In a tenth aspect related to one or more of the previous aspects, configuring the downlink signal may comprise receiving a request to configure the downlink signal, and configuring the downlink signal based at least in part on the request. For example, the request may be received at the cell in a semi-active state from a network entity.

In an eleventh aspect related to one or more of the previous aspects, transmitting the downlink signal comprises transmitting the downlink signal on a synchronization raster. For example, the synchronization raster may correspond to a wireless communication system compatible with the 3GPP Release 15 family of standards. In a twelfth aspect related to the eleventh aspect, the synchronization raster may be a legacy synchronization raster. For example, the legacy synchronization raster may be the synchronization raster of a wireless communication system operating according to the 3GPP Release 15 family of standards, which may be considered by a person skilled in the art the first release of the 5G NR wireless communication standard. In a thirteenth aspect related to the eleventh aspect, the synchronization raster may be different from a legacy synchronization raster.

In a fourteenth aspect relating to one or more of the previous aspects, the synchronization raster may be selected from a plurality of synchronization rasters based at least in part on a configuration of the downlink signal. In a fifteenth aspect related to one or more of the previous aspects, configuring the downlink signal may comprise configuring the downlink signal to indicate at least one other synchronization raster, wherein the at least one other synchronization raster may be configured to carry at least one other downlink signal configured to assist the at least one UE (e.g., UE 115 in FIG. 8 and/or FIG. 9) to detect the synchronization signal transmitted from the at least one cell in the active state (e.g., cell 105-A in FIG. 9).

In a sixteenth aspect related to one or more of the previous aspects, transmitting the downlink signal may comprise transmitting the downlink signal with a default periodicity. For example, the default periodicity may correspond to the periodicity of transmission of SSBs/CD-SSBs in a wireless communication system compatible with the 3GPP Release 15 family of standards, e.g., 20 milliseconds (ms). In a seventeenth aspect related to one or more of the previous aspects, transmitting the downlink signal may comprise transmitting the downlink signal with a pre-configured periodicity, wherein the pre-configured periodicity may be different from the default periodicity. In some examples, the transmission with the pre-configured periodicity may be less frequent (i.e., the pre-configured periodicity may be larger than the default periodicity). In some examples, the pre-configured periodicity may be a non-negative integer multiple (greater than zero) of the default periodicity (e.g., 40 ms), which may achieve better power/energy savings at the cell(s) in semi-active state(s). In an eighteenth aspect related to one or more of the previous aspects, transmitting the downlink signal may comprise transmitting the downlink signal with a configurable periodicity. For example, a configurable periodicity may improve the flexibility available to a network operator to fine tune the tradeoff between the latency and network energy/power savings.

In a nineteenth aspect related to one of more of the previous aspects, transmitting the downlink signal may comprise transmitting the downlink signal in a beam-sweeping manner. This may advantageously improve the spatial coverage of the transmission and increase the odds for a UE to receive the downlink signal. In a twentieth aspect related to one or more of the previous aspects, the downlink signal may comprise at most two symbols (e.g., OFDM symbols), and/or the pre-configured range may exceed a threshold. In one example, the threshold may be greater than or equal to a first value (e.g., 15) for the negative AFS signal (see, e.g., FIG. 6A), and greater than or equal to a second value (e.g., 256) for the positive AFS signal (see, e.g., FIG. 6B). In a twenty-first aspect related to one or more of the previous aspects, the downlink signal may comprise a reference signal in a preamble (e.g., like a primary synchronization signal (PSS)). The preamble may occupy only the first symbol. In the first symbol and/or in the second symbol, the downlink signal may comprise additional assistance information, which may be time division multiplexed (TDM-ed) and/or frequency division multiplexed (FDM-ed) with the preamble. In a twenty-second aspect related to one or more of the previous aspects, the additional assistance information may comprise one or more of periodicity/timing information, cell identification information, synchronization raster offset information, etc.

In a twenty-third aspect related to one or more of the previous aspects, the cell in a semi-active state may receive from a network entity information for configuring the downlink signal. Furthermore, in a related twenty-fourth aspect, the information for configuring the downlink signal may comprise one or more of: time and/or frequency resources configuration, periodicity/timing information, transmission power settings, and beamforming configuration information.

In a twenty-fifth aspect related to one or more of the previous aspects, the cell in the semi-active state may further determine that the at least one UE has established a connection with the at least one cell in the active state. The cell in the semi-active state may transmit additional assistance information to the at least one UE based at least in part on the determining, wherein the additional assistance information may be configured to assist the at least one UE with one or more of: a subsequent access procedure, a cell reselection procedure, and a radio resource management (RRM) measurements procedure. In a twenty-sixth aspect related to one or more of the previous aspects, the cell in the semi-active state may receive a notification that the at least one UE has received the downlink signal.

In a twenty-seventh aspect related to one or more of the previous aspects, the additional assistance information may be carried on a non-legacy Physical Broadcast Channel (PBCH), i.e., a PBCH different from a legacy PBCH of a wireless communication system operating according to the 3GPP Release 15 family of standards. Alternatively, the additional assistance information may be carried on a Physical Downlink Shared Chanel (PDSCH), a Physical Downlink Control Channel (PDCCH), or a combination thereof.

In a twenty-eighth aspect related to one or more of the previous aspects, the additional assistance information may comprise the exact locations on the synchronization raster and/or timing of the SSBs (both CD-SSBs and non-CD-SSBs), other types of AFS signals, as well as other information.

In a twenty-ninth aspect related to one or more of the previous aspects, configuring the downlink signal may comprise configuring the downlink signal to assist the at least one UE to detect the synchronization signal transmitted from the at least one cell in the active state on a synchronization raster, and wherein transmitting the downlink signal comprises transmitting the downlink signal during the semi-active state on a frequency raster which is different from said synchronization raster.

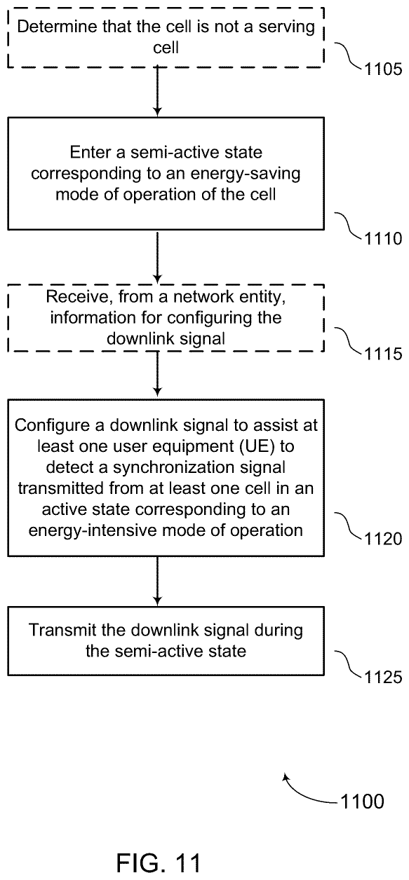

FIG. 11 shows a flowchart illustrating a method 1100 of wireless communication by (or at) a cell (e.g., base station, network node, gNB, etc.) in accordance with some aspect of the disclosure. Optionally, at 1105, the cell may determine that it is not a serving cell. For example, the cell may determine that it has not served any UE for a certain period of time, which may be predetermined or configurable, as described in more detail in connection with FIG. 10. At 1110, the cell may enter a semi-active state corresponding to an energy-saving (ES) mode of operation of the cell. Optionally, the cell may enter the semi-active state, at 1110, based at least in part on the cell determining, at 1105, that it is not a serving cell. Optionally, at 1115, the cell may receive from a network entity information for configuring the downlink signal. At 1120, the cell may configure a downlink signal to assist at least one UE to detect a synchronization signal transmitted from at least one cell in an active state corresponding to an energy intensive mode of operation. The configuring of the downlink signal, at 1120, may be based at least in part on the information received at 1115. Finally, at 1125, the cell may transmit the downlink signal.

Some steps of the method 1100 correspond to the steps of the method 1000 shown in FIG. 10, and the description of those steps in connection with FIG. 10 applies mutatis mutandis to the corresponding steps of the method 1100. Some steps of the method 1100 may represent optional aspects of the disclosure. For example, to emphasize the optional aspect, steps 1105, 1115 are shown each in a box with dashed line.

The downlink signal may be an AFS signal as illustrated in one or more of the preceding figures (e.g., FIGS. 6A-6C and/or FIGS. 7A-7B). The cell in the semi-active state and the cell in the active state may belong to the same network node (e.g., base station, gNB, etc.). Alternatively, they may belong to different network nodes as illustrated, for example, in FIG. 9, where Cell B (105-B) represents the cell in the semi-active state and Cell A (105-A) represents the cell in the active state. Moreover, in related aspects there may be a first plurality of cells in the semi-active state and a second plurality of cells in the active state exchanging signaling with the same UE or with different UEs.

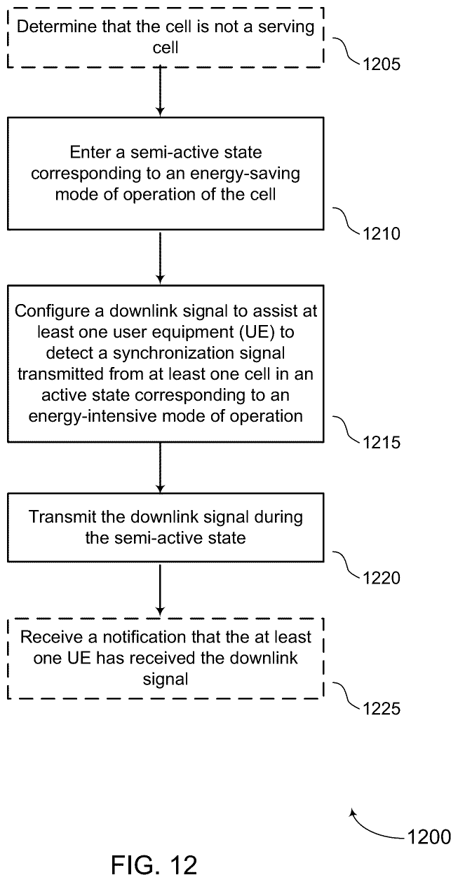

FIG. 12 shows a flowchart illustrating a method 1200 for wireless communication by (or at) a cell (e.g., base station, network node, gNB, etc.) in accordance with some aspects of the present disclosure. Optionally, at 1205, the cell may determine that it is not a serving cell. For example, the cell may determine that it has not served any UE for a certain period of time, which may be predetermined or configurable, as described in more detail in connection with FIG. 10. At 1210, the cell may enter a semi-active state corresponding to an energy-saving mode of operation of the cell. Optionally, the cell may enter the semi-active state, at 1210, based at least in part on the cell determining, at 1205, that it is not a serving cell. At 1215, the cell may configure a downlink signal to assist at least one UE to detect a synchronization signal transmitted from at least one cell in an active state corresponding to an energy-intensive mode of operation. Although not explicitly shown in FIG. 12, the configuring, at 1215, may be based at least in part on the cell receiving from a network entity information for configuring the downlink signal (e.g., as shown in FIG. 11, at 1115). At 1220, the cell may transmit the downlink signal during the semi-active state. Optionally, at 1225, the cell may receive a notification that at least one UE has received the downlink signal.

Some steps of the method 1200 correspond to the steps of the method 1000 shown in FIG. 10, and the description of those steps in connection with FIG. 10 applies mutatis mutandis to the corresponding steps of the method 1200. Some steps of the method 1200 may represent optional aspects of the disclosure. For example, to emphasize the optional aspect, steps 1205, 1225 are shown each in a box with dashed line.

The downlink signal may be an AFS signal as illustrated in one or more of the preceding figures (e.g., FIGS. 6A-6C and/or FIGS. 7A-7B). The cell in the semi-active state and the cell in the active state may belong to the same network node (e.g., base station, gNB, etc.). Alternatively, they may belong to different network nodes as illustrated, for example, in FIG. 9, where Cell B (105-B) represents the cell in the semi-active state and Cell A (105-A) represents the cell in the active state. Moreover, in related aspects there may be a first plurality of cells in the semi-active state and a second plurality of cells in the active state exchanging signaling with the same UE or with different UEs.

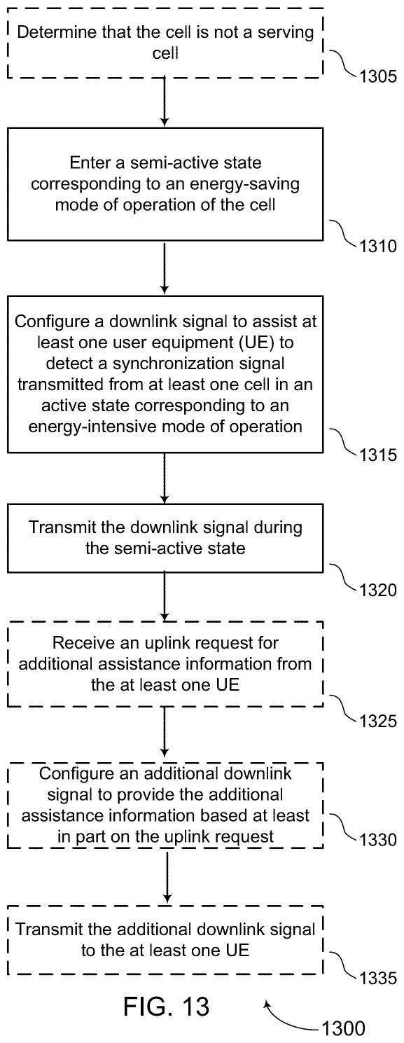

FIG. 13 shows a flowchart illustrating a method 1300 for wireless communication by (or at) a cell (e.g., base station, network node, gNB, etc.) in accordance with some aspects of the present disclosure. Optionally, at 1305, the cell may determine that it is not a serving cell. For example, the cell may determine that it has not served any UE for a certain period of time, which may be predetermined or configurable, as described in more detail in connection with FIG. 10. At 1310, the cell may enter a semi-active state corresponding to an energy-saving mode of operation of the cell. Optionally, the cell may enter the semi-active state, at 1310, based on determining, at 1305, that it is not a serving cell. At 1315, the cell may configure a downlink signal to assist at least one UE to detect a synchronization signal transmitted from at least one cell in an active state corresponding to an energy-intensive mode of operation. Optionally, although not shown in FIG. 13, the cell may configure the downlink signal based at least in part on receiving from a network entity information for configuring the downlink signal (e.g., as shown in FIG. 11, at 1115). At 1320, the cell may transmit the downlink signal during the semi-active state. Optionally, at 1325, the cell may receive an uplink request for additional assistance info from the at least one UE. Further optionally, at 1330, the cell may configure an additional downlink signal to provide the additional assistance information based at least in part on the uplink request, and transmit, at 1335, the additional downlink signal to the at least one UE.

Some steps of the method 1300 correspond to the steps of the method 1000 shown in FIG. 10, and the description of those steps in connection with FIG. 10 applies mutatis mutandis to the corresponding steps of the method 1300. Some steps of the method 1300 may represent optional aspects of the disclosure. For example, to emphasize the optional aspect, steps 1305, 1325, 1330, 1335 are shown each in a box with dashed line.

The downlink signal may be an AFS signal as illustrated in one or more of the preceding figures (e.g., FIGS. 6A-6C and/or FIGS. 7A-7B). The cell in the semi-active state and the cell in the active state may belong to the same network node (e.g., base station, gNB, etc.). Alternatively, they may belong to different network nodes as illustrated, for example, in FIG. 9, where Cell B (105-B) represents the cell in the semi-active state and Cell A (105-A) represents the cell in the active state. Moreover, in related aspects there may be a first plurality of cells in the semi-active state and a second plurality of cells in the active state exchanging signaling with the same UE or with different UEs.

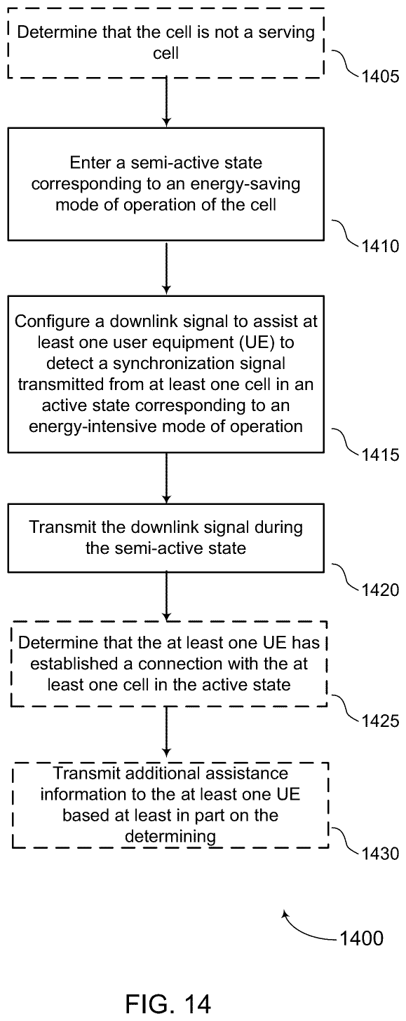

FIG. 14 shows a flowchart illustrating another method 1400 for wireless communication by (or at) a cell (e.g., base station, network node, gNB, etc.). Optionally, at 1405, the cell may determine that it is not a serving cell. For example, the cell may determine that it has not served any UE for a certain period of time, which may be predetermined or configurable, as described in more detail in connection with FIG. 10. At 1410, the cell may enter a semi-active state corresponding to an energy-saving mode of operation of the cell. At 1415, the cell may configure a downlink signal to assist at least one user equipment (UE) to detect a synchronization signal transmitted from at least one cell in an active state corresponding to an energy-intensive mode of operation. At 1420, the cell may transmit the downlink signal during the semi-active state. Optionally, at 1425, the cell may determine that the at least one UE has established a connection with the at least one cell in the active state. For example, the cell may receive a notification from the UE and/or a network entity. In one example, the network entity may be the at least one cell in the active state. Further optionally, at 1430, the cell may transmit additional assistance information to the at least one UE, based at least in part on the determining.

Some steps of the method 1400 correspond to the steps of the method 1000 shown in FIG. 10, and the description of those steps in connection with FIG. 10 applies mutatis mutandis to the corresponding steps of the method 1400. Some steps of the method 1400 may represent optional aspects of the disclosure. For example, to emphasize the optional aspect, steps 1405, 1425, 1430 are shown each in a box with dashed line.

The downlink signal may be an AFS signal as illustrated in one or more of the preceding figures (e.g., FIGS. 6A-6C and/or FIGS. 7A-7B). The cell in the semi-active state and the cell in the active state may belong to the same network node (e.g., base station, gNB, etc.). Alternatively, they may belong to different network nodes as illustrated, for example, in FIG. 9, where Cell B (105-B) represents the cell in the semi-active state and Cell A (105-A) represents the cell in the active state. Moreover, in related aspects there may be a first plurality of cells in the semi-active state and a second plurality of cells in the active state exchanging signaling with the same UE or with different UEs.

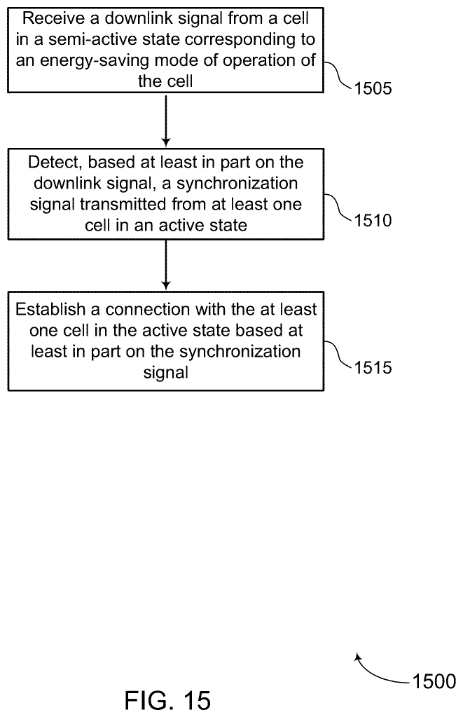

FIG. 15 shows a flowchart illustrating a method 1500 for wireless communication by (or at) a user equipment (UE) in accordance with a first (UE-related) aspect of the present disclosure. At 1505, the UE may receive a downlink signal from a cell (e.g., base station, network node, gNB, etc.) in a semi-active state corresponding to an energy-saving mode of operation of the cell. The cell may be operating according to any of the methods 1000, 1100, 1200, 1300, 1400 illustrated in the flowcharts of FIGS. 10-14. At 1510, the UE may detect based at least in part on the downlink signal, a synchronization signal (e.g., SSBs, CD-SSBs) transmitted from at least one cell in an active state. Therefore, in addition to the network energy savings realized by the cell (or a plurality of cells) in the semi-active state, the UE (or a plurality of UEs) may save battery power by avoiding an extensive search over all possible synchronization frequency channels on one or more frequency rasters of the wireless communication system, which would otherwise be required in order to find the cell in the active state. The combined energy savings (cells and UEs) may be regarded as an environmentally friendly, “green technology” for advanced wireless communications. Finally, at 1515, the cell may establish a connection with the at least one cell in the active state based at least in part on the synchronization signal.

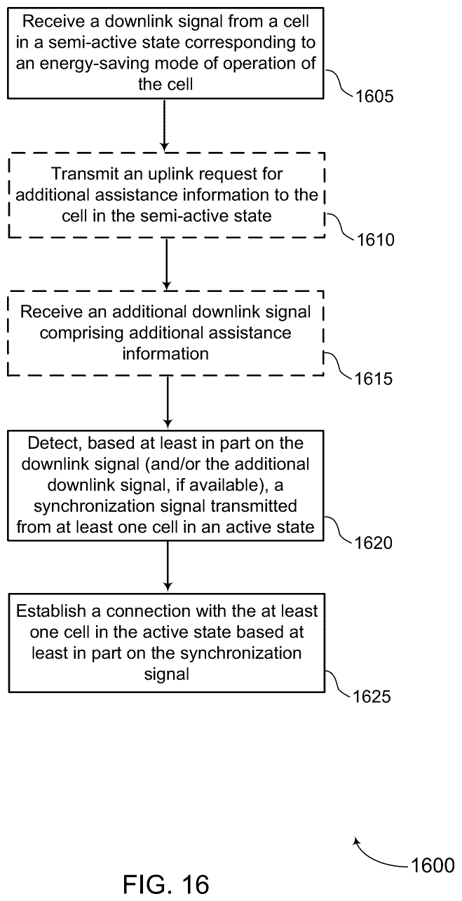

The method 1500 may comprise further optional steps (not shown in FIG. 15) according to one or more related examples and/or aspects described below. In one example, detecting the synchronization signal may comprises the UE configuring its transceiver, based at least in part on the downlink signal received from the cell in the semi-active state, to receive the synchronization signal transmitted from the at least one cell in the active state, and receiving the synchronization signal. In another related example or aspect (illustrated in the flowchart of FIG. 16), the method may optionally comprise transmitting an uplink request for additional assistance information to the cell in the semi-active state, and receiving an additional downlink signal comprising additional assistance information, wherein detecting the synchronization signal transmitted from the at least one cell in the active state is further based at least in part on the additional downlink signal.

The downlink signal may be an AFS signal as illustrated in one or more of the preceding figures (e.g., FIGS. 6A-6C and/or FIGS. 7A-7B). The cell in the semi-active state and the cell in the active state may belong to the same network node (e.g., base station, gNB, etc.). Alternatively, they may belong to different network nodes as illustrated, for example, in FIG. 9, where Cell B (105-B) represents the cell in the semi-active state and Cell A (105-A) represents the cell in the active state. Moreover, in related aspects there may be a first plurality of cells in the semi-active state and a second plurality of cells in the active state exchanging signaling with the same UE or with different UEs.

In a second aspect related to the first (UE-related) aspect described above, the downlink signal may be configured to indicate implicitly at least one frequency channel corresponding to the at least one cell in the active state. In a third aspect related to the second aspect, the downlink signal may be configured to indicate implicitly that the at least one frequency channel is within a pre-configured range on a frequency raster, e.g., relative to a frequency channel corresponding to the cell in the semi-active state. In a fourth aspect related to the second aspect, the downlink signal may be configured to indicate implicitly that the at least one frequency channel is not within a pre-configured range on a frequency raster, e.g., relative to a frequency channel corresponding to the cell in the semi-active state.

In a fifth aspect related to the first (UE-related) aspect, the downlink signal may be configured to indicate explicitly at least one frequency channel corresponding to the at least one cell in the active state. In a sixth aspect related to the fifth aspect, the downlink signal may be configured to indicate explicitly that the at least one frequency channel is within a specified range on the frequency raster, e.g., relative to a frequency channel corresponding to the cell in the semi-active state. In a seventh aspect related to the fifth aspect, the downlink signal may be configured to indicate explicitly that the at least one frequency channel is not within a specified range on the frequency raster, e.g., relative to a frequency channel corresponding to the cell in the semi-active state.

In an eighth aspect related to any of the previous aspects, the UE (e.g., UE 115 in FIG. 8 and/or FIG. 9) may send, and the cell in a semi-active state (e.g., cell 105-B in FIG. 8 and/or FIG. 9) may receive, an uplink request for additional assistance information. In response thereto, the cell in a semi-active state may configure an additional downlink signal to provide the additional assistance information based at least in part on the uplink request. Finally, the cell in a semi-active state may transmit, and the UE may receive, the additional downlink signal (i.e., comprising additional assistance information).

In a ninth aspect related to one or more of the previous aspects, the downlink signal may be configured according to a default configuration. In a tenth aspect related to one or more of the previous aspects, the downlink signal may be configured based at least in part on a request (e.g., from a network entity) to configure the downlink signal.

In an eleventh aspect related to one or more of the previous aspects, the cell in the semi-active state may transmit, and the UE may receive, the downlink signal on a synchronization raster. For example, the synchronization raster may correspond to a wireless communication system compatible with the 3GPP Release 15 family of standards. In a twelfth aspect related to the eleventh aspect, the synchronization raster may be a legacy synchronization raster. For example, the legacy synchronization raster may be the synchronization raster of a wireless communication system operating according to the 3GPP Release 15 family of standards, which may be considered by a person skilled in the art the first release of the 5G NR wireless communication standard. In a thirteenth aspect related to the eleventh aspect, the synchronization raster may be different from a legacy synchronization raster.

In a fourteenth aspect relating to one or more of the previous aspects, the synchronization raster may be selected from a plurality of synchronization rasters based at least in part on a configuration of the downlink signal. In a fifteenth aspect related to one or more of the previous aspects, the downlink signal may be configured to indicate at least one other synchronization raster, wherein the at least one other synchronization raster may be configured to carry at least one other downlink signal configured to assist the UE (e.g., UE 115 in FIG. 8 and/or FIG. 9) to detect the synchronization signal transmitted from the at least one cell in the active state (e.g., cell 105-A in FIG. 9).

In a sixteenth aspect related to one or more of the previous aspects, the downlink signal may be transmitted by the cell in the semi-active state with a default periodicity, known to the UE. For example, the default periodicity may correspond to the periodicity of transmission of SSBs/CD-SSBs in a wireless communication system compatible with the 3GPP Release 15 family of standards, e.g., 20 milliseconds (ms). In a seventeenth aspect related to one or more of the previous aspects, the downlink signal may be transmitted with a pre-configured periodicity, wherein the pre-configured periodicity may be different from the default periodicity. In some examples, the transmission with the pre-configured periodicity may be less frequent (e.g., the pre-configured periodicity may be larger than the default periodicity). In some examples, the pre-configured periodicity may be a non-negative integer multiple (greater than zero) of the default periodicity (e.g., 40 ms), which may achieve better power/energy savings at the cell(s) in semi-active state(s). In an eighteenth aspect related to one or more of the previous aspects, the downlink signal may be transmitted with a configurable periodicity. For example, a configurable periodicity may improve the flexibility available to a network operator to fine tune the tradeoff between the latency and network energy/power savings.

In a nineteenth aspect related to one of more of the previous aspects, the downlink signal may be transmitted in a beam-sweeping manner. This may advantageously improve the spatial coverage of the transmission and increase the odds for a UE to receive the downlink signal. In a twentieth aspect related to one or more of the previous aspects, the downlink signal may comprise at most two symbols (e.g., OFDM symbols), and/or the pre-configured range may exceed a threshold. In one example, the threshold may be greater than or equal to a first value (e.g., 15) for the negative AFS signal (see, e.g., FIG. 6A), and greater than or equal to a second value (e.g., 256) for the positive AFS signal (see, e.g., FIG. 6B). In a twenty-first aspect related to one or more of the previous aspects, the downlink signal may comprise a reference signal in a preamble (e.g., like a primary synchronization signal (PSS)). The preamble may occupy only the first symbol. In the first symbol and/or in the second symbol, the downlink signal may comprise additional assistance information, which may be time division multiplexed (TDM-ed) and/or frequency division multiplexed (FDM-ed) with the preamble. In a twenty-second aspect related to one or more of the previous aspects, the additional assistance information may comprise one or more of periodicity/timing information, cell identification information, synchronization raster offset information, etc.

In a twenty-third aspect related to one or more of the previous aspects, the cell in a semi-active state may receive from a network entity information for configuring the downlink signal (i.e., in a manner transparent to the UE). Furthermore, in a related twenty-fourth aspect, the information for configuring the downlink signal may comprise one or more of: time and/or frequency resources configuration, periodicity/timing information, transmission power settings, and beamforming configuration information.

In a twenty-fifth aspect related to one or more of the previous aspects, the cell in the semi-active state may further determine that the UE has established a connection with the at least one cell in the active state. For example, the UE may notify the cell in the semi-active state of the connection established with the cell in the active state. Alternatively, the cell in the active state may notify the cell in the semi-active state of the connection established with the UE. The cell in the semi-active state may transmit, and the UE may receive, additional assistance information based at least in part on the determining that the UE has established a connection with the cell in the active state, wherein the additional assistance information may be configured to assist the UE with one or more of: a subsequent access procedure, a cell reselection procedure, and a radio resource management (RRM) measurements procedure. In a twenty-sixth aspect related to one or more of the previous aspects, the cell in the semi-active state may receive a notification that the at least one UE has received the downlink signal.

In a twenty-seventh aspect related to one or more of the previous aspects, the additional assistance information may be carried on a non-legacy Physical Broadcast Channel (PBCH), i.e., a PBCH different from a legacy PBCH of a wireless communication system operating according to the 3GPP Release 15 family of standards. Alternatively, the additional assistance information may be carried on a Physical Downlink Shared Chanel (PDSCH), a Physical Downlink Control Channel (PDCCH), or a combination thereof.

In a twenty-eighth aspect related to one or more of the previous aspects, the additional assistance information may comprise the exact locations on the synchronization raster and/or timing of the SSBs (both CD-SSBs and non-CD-SSBs), other types of AFS signals, as well as other information.

In a twenty-ninth aspect related to one or more of the previous aspects, the downlink signal may be configured to assist the UE to detect the synchronization signal transmitted from the at least one cell in the active state on a synchronization raster, and wherein the downlink signal is transmitted by the cell in the semi-active state on a frequency raster which is different from said synchronization raster.

FIG. 16 shows a flowchart illustrating another method 1600 for wireless communication by (or at) a user equipment (UE). At 1605, the UE (e.g., UE 115 in FIG. 8 and/or FIG. 9) may receive a downlink signal from a cell in a semi-active state corresponding to an energy saving mode of operation (e.g., cell 105-B in FIG. 8 and/or FIG. 9). Optionally, at 1610, the UE may transmit, and the cell in the semi-active state (e.g., cell 105-B in FIG. 8 and/or FIG. 9) may receive, as shown in FIG. 13 at 1325, an uplink request for additional assistance information. In response thereto, the cell in the semi-active state may configure an additional downlink signal to provide the additional assistance information based at least in part on the uplink request, as shown in FIG. 13, at 1330. Then, the cell in the semi-active state may transmit, as shown in FIG. 13 at 1335, and the UE may receive, at 1615, the additional downlink signal comprising additional assistance information. Steps 1610 and 1615 of method 1600 are drawn with dashed line in FIG. 16 to emphasize their optional character. At 1620, the UE may detect, based at least in part on the downlink signal and/or the additional downlink signal, if available, a synchronization signal transmitted from at least one cell in an active state. Finally, at 1625, the UE may establish a connection with the at least one cell in the active state based at least in part on the synchronization signal.

The downlink signal may be an AFS signal as illustrated in one or more of the preceding figures (e.g., FIGS. 6A-6C and/or FIGS. 7A-7B). The cell in the semi-active state and the cell in the active state may belong to the same network node (e.g., base station, gNB, etc.). Alternatively, they may belong to different network nodes as illustrated, for example, in FIG. 9, where Cell B (105-B) represents the cell in the semi-active state and Cell A (105-A) represents the cell in the active state. Moreover, in related aspects there may be a first plurality of cells in the semi-active state and a second plurality of cells in the active state exchanging signaling with the same UE or with different UEs.

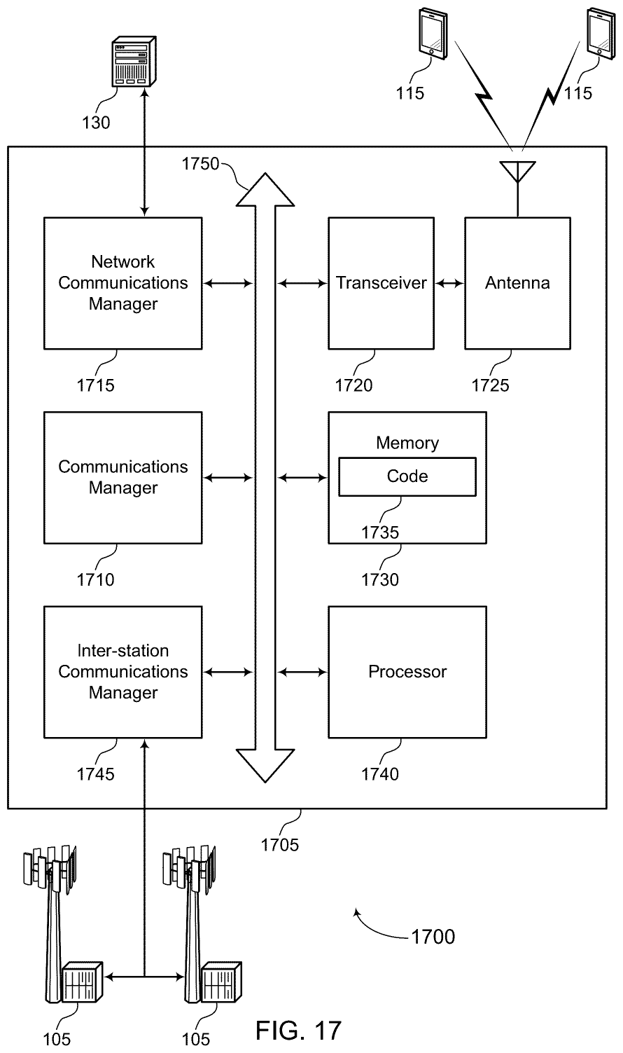

FIG. 17 shows a diagram of a system 1700 comprising an apparatus 1705 for wireless communication by (or at) a cell (e.g., base station, network node, gNB, etc.) in accordance with various aspects of the present disclosure. The apparatus may comprise a processor 1740 and a memory 1730 coupled to the processor 1740. The memory 1730 may comprise code 1735, i.e., instructions stored in the memory 1730 and executable by the processor 1740, to cause to the apparatus 1705 to enter a semi-active state corresponding to an energy-saving mode of operation of the cell, configure a downlink signal to assist at least one UE 115 to detect a synchronization signal transmitted from at least one cell in an active state (i.e., a state corresponding to an energy-intensive mode of operation), and transmit the downlink signal during the semi-active state. Optionally, the memory 1730 may further comprise instructions executable by the processor 1740 to cause the apparatus to determine that the cell is not a serving cell, wherein the apparatus 1705 may enter the semi-active state based at least in part on the determining that the cell is not an active cell. Further optionally, the memory 1730 may comprise instructions executable by the processor 1740 to cause the apparatus 1705 to carry out any of the methods described in connection with FIGS. 10-14.

The downlink signal may be an AFS signal as illustrated in one or more of the preceding figures (e.g., FIGS. 6A-6C and/or FIGS. 7A-7B). The cell in the semi-active state and the cell in the active state may belong to the same network node (e.g., base station, gNB, etc.). Alternatively, they may belong to different network nodes as illustrated, for example, in FIG. 9, where Cell B (105-B) represents the cell in the semi-active state and Cell A (105-A) represents the cell in the active state. Moreover, in related aspects there may be a first plurality of cells in the semi-active state and a second plurality of cells in the active state exchanging signaling with the same UE or with different UEs.

In addition to the memory 1730 and the processor 1740, the apparatus 1705 may further comprise components for bi-directional voice and data communications comprising components for transmitting and receiving communications, comprising a communications manager 1710, a network communications manager 1715, a transceiver 1720, an antenna 1725 and an inter-station communications manager 1745. These components may be in electronic communication via one or more buses (e.g., bus 1750). Alternatively, the apparatus 1705 may represent a part (e.g., a component, a subsystem, a system-on-a-chip (SoC), etc.) of a wireless device that comprises one or more of the additional components described above. For example, the apparatus may be the smallest marketable unit implementing the various aspects of the present disclosure.

The communication manager 1710 may be primarily responsible for managing communications with one or more UEs 115. The network communications manager 1715 may manage communications with the core network (e.g., via one or more wired backhaul links) For example, the network communications manager 1715 may manage the transfer of data communications for client devices, such as the one or more UEs 115.

The transceiver 1720 may communicate bi-directionally, via one or more antennas, wired, or wireless links as described above. For example, the transceiver 1720 may represent a wireless transceiver and may communicate bi-directionally with another wireless transceiver. The transceiver 1720 may also comprise a modem to modulate the packets and provide the modulated packets to the antennas for transmission, and to demodulate packets received from the antennas.

In some cases, the apparatus 1705 or, alternatively, the wireless device comprising the apparatus 1705, may comprise a single antenna 1725. However, in some cases the apparatus 1705 may have more than one antenna 1725, which may be capable of concurrently transmitting or receiving multiple wireless transmissions.

The memory 1730 may comprise RAM, ROM, or a combination thereof. The memory 1730 may store computer-readable code 1735 comprising instructions that, when executed by a processor (e.g., the processor 1740) cause the apparatus 1705 to perform various functions described herein. In some cases, the memory 1730 may contain, among other things, a BIOS which may control basic hardware or software operation such as the interaction with peripheral components or devices.

The processor 1740 may comprise an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1740 may be configured to operate a memory array using a memory controller. In some cases, a memory controller may be integrated into processor 1740. The processor 1740 may be configured to execute computer-readable instructions stored in a memory (e.g., the memory 1740) to cause the device 1705 to perform various functions (e.g., functions or tasks supporting methods for power savings with millimeter wave relays).

The inter-station communications manager 1745 may manage communications with other base station 105, and may comprise a controller or scheduler for controlling communications with UEs 115 in cooperation with other base stations 105. For example, the inter-station communications manager 1745 may coordinate scheduling for transmissions to UEs 115 for various interference mitigation techniques such as beamforming or joint transmission. In some examples, the inter-station communications manager 1745 may provide an X2 interface within an LTE/LTE-A wireless communication network technology to provide communication between base stations 105.

The code 1735 may comprise instructions to implement aspects of the present disclosure, comprising instructions to support wireless communications. The code 1735 may be stored in a non-transitory computer-readable medium such as system memory or other type of memory. In some cases, the code 1735 may not be directly executable by the processor 1740 but may cause a computer (e.g., when compiled and executed) to perform functions described herein.

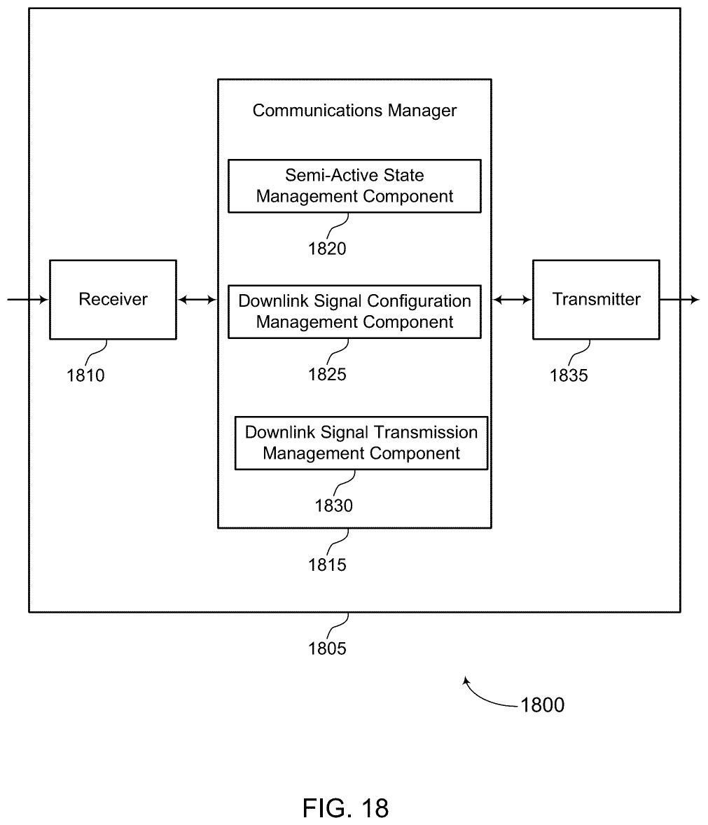

FIG. 18 shows a block diagram 1800 of an apparatus 1805 for wireless communication by (or at) a cell (e.g., base station, network node, gNB, etc.) in accordance with aspects of the present disclosure. The apparatus 1805 may comprise a communications manager 1815, a receiver 1810 and a transmitter 1835. However, in some aspects, the apparatus 1805 may comprise solely the communications manager 1815, which may represent the smallest marketable unit implementing the various aspects of the present disclosure (e.g., a component, a subsystem, a system-on-a-chip (SoC)).

The communication manager 1815 may comprise means for entering a semi-active state corresponding to an energy-saving mode of operation of the cell, e.g., the semi-active state management component 1820. Optionally, the communication manager 1815 may comprise means for determining that the cell is not a serving cell (not shown in FIG. 18), wherein the means for entering the semi-active state, i.e., the semi-active state management component 1820, may be operable based at least in part on the output of the means for determining that the cell is not a serving cell. The communication manager 1815 may further comprise means for configuring a downlink signal to assist at least one UE 115 to detect a synchronization signal transmitted from at least one cell in an active state corresponding to an energy-intensive mode of operation, e.g., the downlink signal configuration management component 1825. The communication manager 1815 may comprise means for transmitting the downlink signal (or, alternatively, means for managing the transmission) during the semi-active state, e.g., the downlink signal transmission management component 1830.

Optionally, the communication manager 1815 and/or the apparatus 1805 may comprise further means and/or management components configured to execute one or more of the methods described with their various aspects in connection with FIGS. 10-14.

The downlink signal may be an AFS signal as illustrated in one or more of the preceding figures (e.g., FIGS. 6A-6C and/or FIGS. 7A-7B). The cell in the semi-active state and the cell in the active state may belong to the same network node (e.g., base station, gNB, etc.). Alternatively, they may belong to different network nodes as illustrated, for example, in FIG. 9, where Cell B (105-B) represents the cell in the semi-active state and Cell A (105-A) represents the cell in the active state. Moreover, in related aspects there may be a first plurality of cells in the semi-active state and a second plurality of cells in the active state exchanging signaling with the same UE or with different UEs.

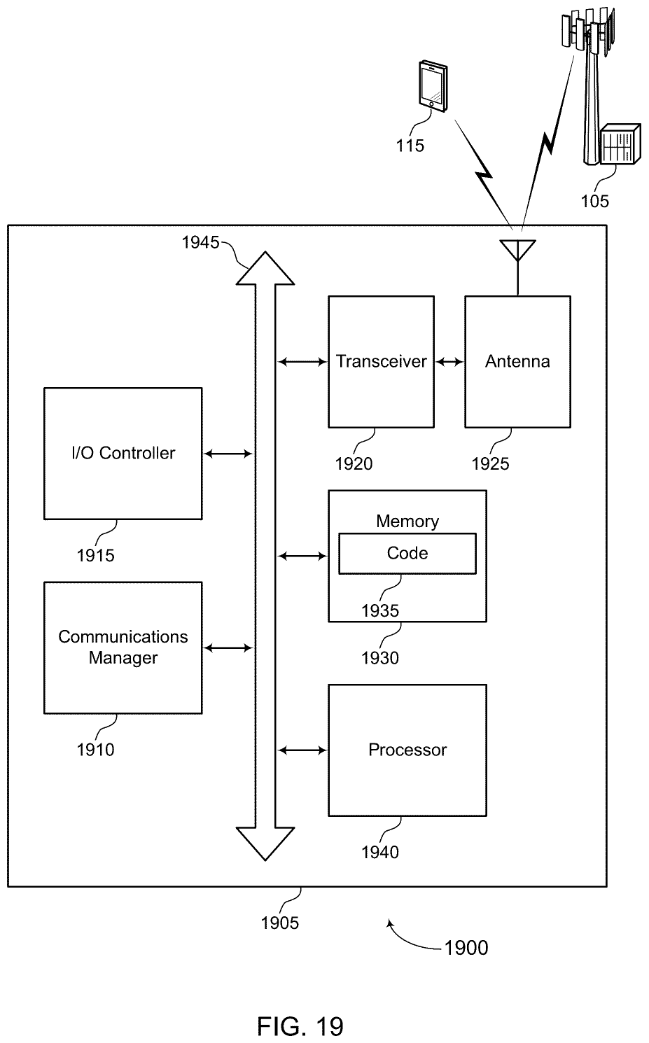

FIG. 19 shows a diagram of a system 1900 comprising an apparatus 1905 for wireless communication by (or at) a UE 115 in accordance with various aspects of the present disclosure. The apparatus may comprise a processor 1940 and a memory 1930 coupled to the processor 1940. The memory 1930 may comprise code 1935, i.e., instructions stored in the memory 1930 and executable by the processor 1940, to cause to the apparatus 1905 to receive a downlink signal from a cell in a semi-active state corresponding to an energy-saving mode of operation of the cell. The instructions may also cause the apparatus 1905 to detect, based at least in part on the downlink signal, a synchronization signal transmitted from at least one cell in an active state. The active state may correspond to an energy-intensive mode of operation of the at least one cell. Further, the instructions may cause the apparatus 1905 to establish a connection with the at least one cell in the active state based at least in part on the synchronization signal.

Optionally, the memory 1930 may further comprise instructions executable by the processor 1940 to cause the apparatus 1905 to implement any of the aspects described in connection with FIGS. 15-16.

The downlink signal may be an AFS signal as illustrated in one or more of the preceding figures (e.g., FIGS. 6A-6C and/or FIGS. 7A-7B). The cell in the semi-active state and the cell in the active state may belong to the same network node (e.g., base station, gNB, etc.). Alternatively, they may belong to different network nodes as illustrated, for example, in FIG. 9, where Cell B (105-B) represents the cell in the semi-active state and Cell A (105-A) represents the cell in the active state. Moreover, in related aspects there may be a first plurality of cells in the semi-active state and a second plurality of cells in the active state exchanging signaling with the same UE or with different UEs.

The apparatus 1905 may comprise components for bi-directional voice and data communications comprising components for transmitting and receiving communications, comprising a communications manager 1910, an I/O controller 1915, a transceiver 1920, an antenna 1925, memory 1930, and a processor 1940. These components may be in electronic communication via one or more buses (e.g., bus 1945).

The communications manager 1910 may be primarily responsible for managing communications with one or more cells 105, which may comprise one or more cells in a semi-active state and one or more cells in the active state according to various aspects of the present disclosure. Additionally, the communications manager 1910 may be responsible for managing communication with one or more UEs 115 (e.g., using sidelink communication).

The I/O controller 1915 may manage input and output signals for the device 1905. The I/O controller 1915 may also manage peripherals not integrated into the apparatus 1905. In some cases, the I/O controller 1915 may represent a physical connection or port to an external peripheral. In some cases, the I/O controller 1915 may utilize an operating system such as iOS®, ANDROID®, MS-DOS®, MS-WINDOWS®, OS/2®, UNIX®, LINUX®, or another known operating system. In other cases, the I/O controller 1915 may represent or interact with a modem, a keyboard, a mouse, a touchscreen, or a similar device. In some cases, the I/O controller 1915 may be implemented as part of a processor. In some cases, a user may interact with the device 1905 via the I/O controller 1915 or via hardware components controlled by the I/O controller 1915.

The transceiver 1920 may communicate bi-directionally, via one or more antennas, wired, or wireless links as described above. For example, the transceiver 1920 may represent a wireless transceiver and may communicate bi-directionally with another wireless transceiver. The transceiver 1920 may also comprise a modem to modulate the packets and provide the modulated packets to the antennas for transmission, and to demodulate packets received from the antennas.

In some cases, the apparatus 1905 may comprise a single antenna 1925. However, in some cases the apparatus 1905 may have more than one antenna 1925, which may be capable of concurrently transmitting or receiving multiple wireless transmissions. Each antenna 1925 may comprise one or more phasors.

The memory 1930 may comprise RAM and ROM. The memory 1930 may store computer-readable, computer-executable code 1935 comprising instructions that, when executed, cause the processor to perform various functions described herein. In some cases, the memory 1930 may contain, among other things, a BIOS which may control basic hardware or software operation such as the interaction with peripheral components or devices.

The processor 1940 may comprise an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1940 may be configured to operate a memory array using a memory controller. In other cases, a memory controller may be integrated into the processor 1940. The processor 1940 may be configured to execute computer-readable instructions stored in a memory (e.g., the memory 1930) to cause the device 1905 to perform basic functions (e.g., functions or tasks supporting beam selection in handheld wireless communications devices) in addition to the functions described herein.

The code 1935 may comprise instructions to implement aspects of the present disclosure, comprising instructions to support wireless communications. The code 1935 may be stored in a non-transitory computer-readable medium such as system memory or other type of memory. In some cases, the code 1935 may not be directly executable by the processor 1940 but may cause a computer (e.g., when compiled and executed) to perform the functions described herein.

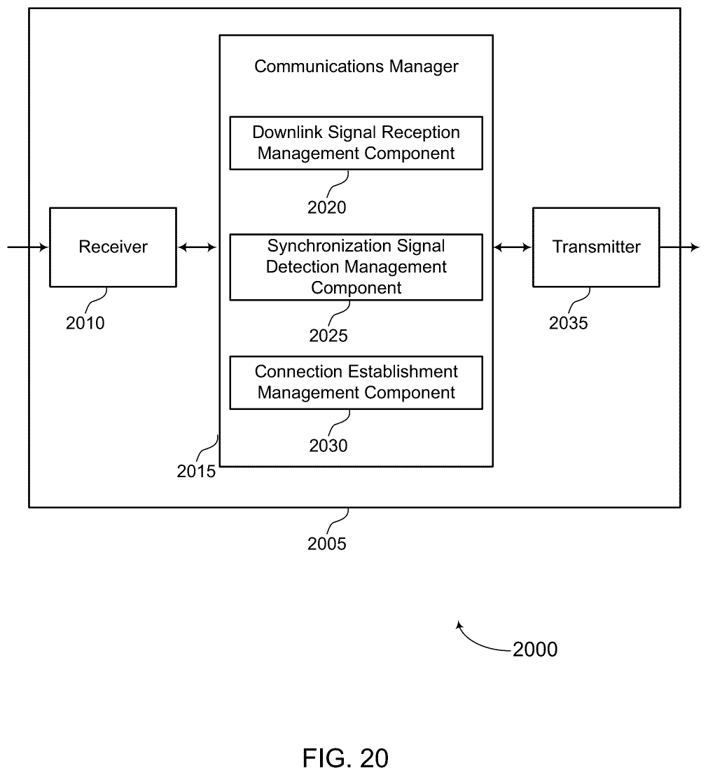

FIG. 20 shows a block diagram 2000 of an apparatus 2005 for wireless communication by (or at) a UE 115 in accordance with aspects of the present disclosure. The apparatus 2005 may comprise a communications manager 2015, a receiver 2010 and a transmitter 2035. However, in some aspects, the apparatus 2005 may comprise solely the communications manager 2005, which may represent the smallest marketable unit implementing the various aspects of the present disclosure (e.g., a component, a subsystem, a system-on-a-chip (SoC)).

The communication manager 2015 may comprise means for receiving a downlink signal from a cell in a semi-active state corresponding to an energy-saving mode of operation of the cell, e.g., the downlink signal reception management component 2020. The communication manager 2015 may also comprise means for detecting, based at least in part on the downlink signal, a synchronization signal transmitted from at least one cell in an active state, e.g., the synchronization signal detection management component 2025. The communication manager 2015 may further comprise means for establishing a connection with the at least one cell in the active state based at least in part on the synchronization signal, e.g., the connection establishment management component 2030.

Optionally, the communication manager 2015 and/or the apparatus 2005 may comprise further means and/or management components configured to execute one or more of the methods described with their various aspects in connection with FIGS. 15-16.

The downlink signal may be an AFS signal as illustrated in one or more of the preceding figures (e.g., FIGS. 6A-6C and/or FIGS. 7A-7B). The cell in the semi-active state and the cell in the active state may belong to the same network node (e.g., base station, gNB, etc.). Alternatively, they may belong to different network nodes as illustrated, for example, in FIG. 9, where Cell B (105-B) represents the cell in the semi-active state and Cell A (105-A) represents the cell in the active state. Moreover, in related aspects there may be a first plurality of cells in the semi-active state and a second plurality of cells in the active state exchanging signaling with the same UE or with different UEs.

It should be noted that the methods described herein describe possible implementations, and that the operations and the steps may be rearranged or otherwise modified, and that other implementation are possible. Furthermore, aspects from two or more of the methods may be combined.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, comprising being distributed such that portions of functions are implemented at different physical locations.

Computer-readable media comprises both non-transitory computer storage media and communication media comprising any medium that facilitates transfer of a computer program from one place to another. A non-transitory storage medium may be any available medium that can be accessed by a general-purpose or special-purpose computer. By way of example, and not limitation, non-transitory computer-readable media may comprise random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are comprised in the definition of medium. Disk and disc, as used herein, comprise CD, laser disc, optical disc, digital versatile disc (DVD), floppy disk and Blu-ray disc where disks usually reproduce data magnetically, while discs reproduce data optically with lasers. Combinations of the above are also comprised within the scope of computer-readable media.

As used herein, comprising in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description comprises specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

The following provides an overview of various examples illustrating different aspects in accordance with the present disclosure:

Example 1: A method for wireless communication by a cell (e.g., of a base station), comprising: (e.g., optionally, determining that the cell is not serving a serving cell) entering a semi-active state corresponding to an energy-saving mode of operation of the cell (e.g., based at least in part on the determining); configuring a downlink signal to assist at least one user equipment (UE) to detect a synchronization signal transmitted from at least one cell in an active state (e.g., corresponding to an energy-intensive mode of operation of the at least one cell); and transmitting the downlink signal during the semi-active state. The downlink signal may be an AFS signal as illustrated in one or more of the preceding figures (e.g., FIGS. 6A-6C and/or FIGS. 7A-7B). The cell in the semi-active state and the cell in the active state may belong to the same network node (e.g., base station, gNB, etc.). Alternatively, they may belong to different network nodes as illustrated, for example, in FIG. 9, where Cell B (105-B) represents the cell in the semi-active state and Cell A (105-A) represents the cell in the active state. Moreover, in related aspects there may be a first plurality of cells in the semi-active state and a second plurality of cells in the active state exchanging signaling with the same UE or with different UEs.

Example 2: The method of example 1, wherein the downlink signal is configured to indicate implicitly at least one frequency channel corresponding to the at least one cell in the active state.

Example 3: The method of one or more of the preceding examples, wherein the downlink signal is configured to indicate implicitly that the at least one frequency channel is within a pre-configured range on a frequency raster (e.g., relative to a frequency channel corresponding to the cell in the semi-active state).

Example 4: The method of one or more of the preceding examples, wherein the downlink signal is configured to indicate implicitly that the at least one frequency channel is not within a pre-configured range on a frequency raster (e.g., relative to a frequency channel corresponding to the cell in the semi-active state).

Example 5: The method of one or more of the preceding examples, wherein the downlink signal is configured to indicate explicitly at least one frequency channel corresponding to the at least one cell in the active state.

Example 6: The method of one or more of the preceding examples, wherein the downlink signal is configured to indicate explicitly that the at least one frequency channel is within a specified range on the frequency raster (e.g., relative to a frequency channel corresponding to the cell in the semi-active state).

Example 7: The method of one or more of the preceding examples, wherein the downlink signal is configured to indicate explicitly that the at least one frequency channel is not within an specified range on the frequency raster (e.g., relative to a frequency channel corresponding to the cell in the semi-active state).

Example 8: The method of one or more of the preceding examples, further comprising: receiving an uplink request for additional assistance information from the at least one UE; configuring an additional downlink signal to provide the additional assistance information based at least in part on the uplink request; and transmitting the additional downlink signal to the at least one UE.

Example 9: The method of one or more of the preceding examples, wherein configuring the downlink signal comprises: configuring the downlink signal according to a default configuration.

Example 10. The method of one or more of the preceding examples, wherein configuring the downlink signal comprises: receiving (e.g., from a network entity) a request to configure the downlink signal; and configuring the downlink signal based at least in part on the request.

Example 11: The method of one or more of the preceding examples, wherein transmitting the downlink signal comprises: transmitting the downlink signal on a synchronization raster.

Example 12: The method of one or more of the preceding examples, wherein the synchronization raster is a legacy synchronization raster (e.g., the legacy synchronization raster corresponds to a wireless communication system compatible with, or operating according to, the 3GPP Release 15 family of standards).

Example 13: The method of one or more of the preceding examples, wherein the synchronization raster is different from a legacy synchronization raster (e.g., the legacy synchronization raster corresponds to a wireless communication system compatible with, or operating according to, the 3GPP Release 15 family of standards).

Example 14: The method of one or more of the preceding examples, wherein the synchronization raster is selected from a plurality of synchronization rasters based at least in part of a configuration of the downlink signal.

Example 15: The method of one or more of the preceding examples, wherein configuring the downlink signal comprises: configuring the downlink signal to indicate at least one other synchronization raster, wherein the at least one other synchronization raster is adapted to carry at least one other downlink signal configured to assist the at least one UE to detect the synchronization signal transmitted from the at least one cell in the active state.

Example 16: The method of one or more of the preceding examples, wherein transmitting the downlink signal comprises: transmitting the downlink signal with a default periodicity (e.g., 20 ms, of a synchronization system block (SSB) of a wireless communication system compatible with, or operating according to, the 3GPP Release 15 family of standards).

Example 17: The method of one or more of the preceding examples, wherein transmitting the downlink signal comprises: transmitting the downlink signal with a pre-configured periodicity (e.g., 40 ms), wherein the pre-configured periodicity is different (e.g., less frequent for better power saving in the semi-active state) from a default periodicity (e.g., 20 ms, of a synchronization system block (SSB) of a wireless communication system compatible with, or operating according to, the 3GPP Release 15 family of standards).

Example 18: The method of one or more of the preceding examples, wherein transmitting the downlink signal comprises: transmitting the downlink signal with a configurable periodicity.

Example 19: The method of one or more of the preceding examples, wherein transmitting the downlink signal comprises: transmitting the downlink signal in a beam-sweeping manner.

Example 20: The method of one or more of the preceding examples, wherein the downlink signal comprises at most two symbols, and/or wherein the pre-configured range exceeds a threshold. In one example, the threshold may be greater than or equal to a first value (e.g., 15) for the negative AFS signal (see, e.g., FIG. 6A), and greater than or equal to a second value (e.g., 256) for the positive AFS signal (see, e.g., FIG. 6B).

Example 21: The method of one or more of the preceding examples, wherein the downlink signal comprises: a reference signal (e.g., like PSS) in a preamble (e.g., in a first symbol); and additional assistance information (e.g., timing info, ID info, sync raster offset info, etc.) in the same or another symbol (e.g., TDM-ed or FDM-ed w/ preamble).

Example 22: The method of one or more of the preceding examples, wherein the additional assistance information comprises one or more of: periodicity (i.e., timing) information, cell identification information, synchronization raster offset information.

Example 23: The method of one or more of the preceding examples, further comprising: receiving, from a network entity, information for configuring the downlink signal.

Example 24: The method of one or more of the preceding examples, wherein the information for configuring the downlink signal comprises one or more of: time and/or frequency resources configuration, periodicity (e.g., timing) information, transmission power settings, and beamforming configuration information.

Example 25: The method of one or more of the preceding examples, further comprising: determining that the at least one UE has established a connection with the at least one cell in the active state; and transmitting additional assistance information to the at least one UE based at least in part on the determining, wherein the additional assistance information is configured to assist the at least one UE with one or more of a subsequent access procedure, a cell re-selection procedure, and a radio resource management (RRM) measurements procedure.

Example 26: The method of one or more of the preceding examples, further comprising: receiving a notification that the at least one UE has received the downlink signal.

Example 27: The method of one or more of the preceding examples, wherein the additional assistance information is carried on a (e.g., new/non-legacy) Physical Broadcast Channel (PBCH) different from a legacy PBCH (e.g., the legacy PBCH corresponding to a wireless communication system compatible with, or operating according to, the 3GPP Release 15 family of standards), a Physical Downlink Shared Channel (PDSCH), a Physical Downlink Control Channel (PDCCH), or a combination thereof.

Example 28: The method of one or more of the preceding examples, wherein the additional assistance information comprises the exact locations on the synchronization raster and/or timing of the SSBs (both CD-SSBs and non-CD-SSBs), other types of AFS signals, as well as other information.

Example 29: The method of one or more of the preceding examples, wherein configuring the downlink signal comprises configuring the downlink signal to assist the at least one UE to detect the synchronization signal transmitted from the at least one cell in the active state on a synchronization raster; and wherein transmitting the downlink signal comprises transmitting the downlink signal during the semi-active state on a frequency raster which is different from said synchronization raster.

Example 30: A method for wireless communication by a user equipment (UE), comprising: receiving a downlink signal from a cell in a semi-active state corresponding to an energy-saving mode of operation of the cell; detecting, based at least in part on the downlink signal, a synchronization signal transmitted from at least one cell in an active state (e.g., corresponding to an energy-intensive mode of operation of the at least one cell); and establishing a connection with the at least one cell in the active state based at least in part on the synchronization signal. The downlink signal may be an AFS signal as illustrated in one or more of the preceding figures (e.g., FIGS. 6A-6C and/or FIGS. 7A-7B). The cell in the semi-active state and the cell in the active state may belong to the same network node (e.g., base station, gNB, etc.). Alternatively, they may belong to different network nodes as illustrated, for example, in FIG. 9, where Cell B (105-B) represents the cell in the semi-active state and Cell A (105-A) represents the cell in the active state. Moreover, in related aspects there may be a first plurality of cells in the semi-active state and a second plurality of cells in the active state exchanging signaling with the same UE or with different UEs.

Example 31: The method of example 30, further comprising: transmitting an uplink request for additional assistance information to the cell in the semi-active state; and receiving an additional downlink signal comprising additional assistance information; wherein detecting the synchronization signal transmitted from the at least one cell in the active state is further based at least in part on the additional downlink signal.

Example 32: An apparatus for wireless communication by a cell (e.g., of a base station), comprising: a processor; memory coupled with the processor; and instructions stored in the memory and executable by the processor to cause the apparatus to: (e.g., optionally, determine that the cell is not serving a serving cell) enter a semi-active state corresponding to an energy-saving mode of operation of the cell (e.g., based at least in part on the determining); configure a downlink signal to assist at least one user equipment (UE) to detect a synchronization signal transmitted from at least one cell in an active state (e.g., corresponding to an energy-intensive mode of operation of the at least one cell); and transmit the downlink signal during the semi-active state.

Example 33: An apparatus for wireless communication by a cell (e.g., of a base station), comprising: (e.g., optionally, means for determining that the cell is not serving a serving cell) means for entering a semi-active state corresponding to an energy-saving mode of operation of the cell (e.g., based at least in part on the determining); means for configuring a downlink signal to assist at least one user equipment (UE) to detect a synchronization signal transmitted from at least one cell in an active state (e.g., corresponding to an energy-intensive mode of operation of the at least one cell); and means for transmitting the downlink signal during the semi-active state.

Example 34: An apparatus for wireless communication by a user equipment (UE), comprising: a processor; memory coupled with the processor; and instructions stored in the memory and executable by the processor to cause the apparatus to: receive a downlink signal from a cell in a semi-active state corresponding to an energy-saving mode of operation of the cell; detect, based at least in part on the downlink signal, a synchronization signal transmitted from at least one cell in an active state (e.g., corresponding to an energy-intensive mode of operation of the at least one cell); and establish a connection with the at least one cell in the active state based at least in part on the synchronization signal.

Example 35: An apparatus for wireless communication by a user equipment (UE), comprising: means for receiving a downlink signal from a cell in a semi-active state corresponding to an energy-saving mode of operation of the cell; means for detecting, based at least in part on the downlink signal, a synchronization signal transmitted from at least one cell in an active state (e.g., corresponding to an energy-intensive mode of operation of the at least one cell); and means for establishing a connection with the at least one cell in the active state based at least in part on the synchronization signal.

Example 36: A non-transitory computer-readable medium storing a plurality of processor-executable instructions, wherein executing the processor-executable instructions causes one or more processor associated with a cell (e.g., of a base station) to: (e.g., optionally, determine that the cell is not serving a serving cell) enter a semi-active state corresponding to an energy-saving mode of operation of the cell (e.g., based at least in part on the determining); configure a downlink signal to assist at least one user equipment (UE) to detect a synchronization signal transmitted from at least one cell in an active state (e.g., corresponding to an energy-intensive mode of operation of the at least one cell); and transmit the downlink signal during the semi-active state.

Example 37: A non-transitory computer-readable medium storing a plurality of processor-executable instructions, wherein executing the processor-executable instructions causes one or more processor associated with a user equipment (UE) to: receive a downlink signal from a cell in a semi-active state corresponding to an energy-saving mode of operation of the cell; detect, based at least in part on the downlink signal, a synchronization signal transmitted from at least one cell in an active state (e.g., corresponding to an energy-intensive mode of operation of the at least one cell); and establish a connection with the at least one cell in the active state based at least in part on the synchronization signal.

Example 38: A set of computer programs comprising instructions which, when the instructions are executed on at least one processor of an apparatus according to example 31, cause said apparatus to carry out the method of any of examples 1 to 29, and which, when the instructions are executed on at least one processor of an apparatus according to example 33, cause said apparatus to carry out the method of example 30.

Example 39: A method for wireless communication by at least one first cell and at least one second cell, comprising: entering, at the at least one first cell and at the at least one second cell, a semi-active state corresponding to an energy-saving mode of operation of the at least one first cell and the at least one second cell; configuring, at the at least one first cell at least one first downlink signal, and at the at least one second cell at least one second downlink signal, to assist at least one user equipment (UE) to detect on at least one frequency channel a synchronization signal transmitted from at least one cell in an active state (e.g., corresponding to an energy-intensive mode of operation); wherein the at least one first downlink signal is configured to indicate that the at least one frequency channel is within a pre-configured range on a frequency raster, and wherein the at least one second downlink signal is configured to indicate that the at least one frequency channel is not within a pre-configured range on a frequency raster; and transmitting the at least one first downlink signal from the at least first cell, and the at least one second downlink signal from the at least one second cell, during the semi-active state corresponding to an energy-saving mode of operation of the at least one first cell and the at least one second cell. The downlink signal may be an AFS signal as illustrated in one or more of the preceding figures (e.g., FIGS. 6A-6C and/or FIGS. 7A-7B). The cell in the semi-active state and the cell in the active state may belong to the same network node (e.g., base station, gNB, etc.). Alternatively, they may belong to different network nodes as illustrated, for example, in FIG. 9, where Cell B (105-B) represents the cell in the semi-active state and Cell A (105-A) represents the cell in the active state. Moreover, in related aspects there may be a first plurality of cells in the semi-active state and a second plurality of cells in the active state exchanging signaling with the same UE or with different UEs.

Example 40: A method for wireless communication by a user equipment (UE), comprising: receiving at least one first downlink signal from at least one first cell in a semi-active state corresponding to an energy-saving mode of operation of the at least one first cell, wherein the at least one first downlink signal is configured to indicate that at least one frequency channel is within a pre-configured range on a frequency raster; receiving at least one second downlink signal from at least one second cell in a semi-active state corresponding to an energy-saving mode of operation of the at least one second cell, wherein the at least one second downlink signal is configured to indicate that the at least one frequency channel is not within a pre-configured range on a frequency raster; detecting, based at least in part on the one first downlink signal and the at least one second downlink signal, a synchronization signal transmitted on the at least one frequency channel from at least one cell in an active state (e.g., corresponding to an energy-intensive mode of operation of the at least one cell); and establishing a connection with the at least one cell in the active state based at least in part on the synchronization signal. The downlink signal may be an AFS signal as illustrated in one or more of the preceding figures (e.g., FIGS. 6A-6C and/or FIGS. 7A-7B). The cell in the semi-active state and the cell in the active state may belong to the same network node (e.g., base station, gNB, etc.). Alternatively, they may belong to different network nodes as illustrated, for example, in FIG. 9, where Cell B (105-B) represents the cell in the semi-active state and Cell A (105-A) represents the cell in the active state. Moreover, in related aspects there may be a first plurality of cells in the semi-active state and a second plurality of cells in the active state exchanging signaling with the same UE or with different UEs.

1. A method for wireless communication by a cell, comprising:
entering a semi-active state corresponding to an energy-saving mode of operation of the cell;
configuring a downlink signal to assist at least one user equipment (UE) to detect a synchronization signal transmitted from at least one cell in an active state; and
transmitting the downlink signal during the semi-active state.

2. The method of claim 1, wherein:
the downlink signal is configured to indicate implicitly at least one frequency channel corresponding to the at least one cell in the active state.

3. The method of claim 2, wherein:
the downlink signal is configured to indicate implicitly that the at least one frequency channel is within a pre-configured range on a frequency raster.

4. The method of claim 2, wherein:
the downlink signal is configured to indicate implicitly that the at least one frequency channel is not within a pre-configured range on a frequency raster.

5. The method of claim 1, wherein:
the downlink signal is configured to indicate explicitly at least one frequency channel corresponding to the at least one cell in the active state.

6. The method of claim 5, wherein:
the downlink signal is configured to indicate explicitly that the at least one frequency channel is within a specified range on a frequency raster.

7. The method of claim 5, wherein:
the downlink signal is configured to indicate explicitly that the at least one frequency channel is not within an specified range on a frequency raster.

8. The method of any of claim 7, further comprising:
receiving an uplink request for additional assistance information from the at least one UE;
configuring an additional downlink signal to provide the additional assistance information based at least in part on the uplink request; and
transmitting the additional downlink signal to the at least one UE.

9. The method of claim 1, wherein configuring the downlink signal comprises:
configuring the downlink signal according to a default configuration.

10. The method of claim 1, wherein configuring the downlink signal comprises:
receiving a request to configure the downlink signal; and
configuring the downlink signal based at least in part on the request.

11. The method of claim 1, wherein transmitting the downlink signal comprises:
transmitting the downlink signal on a synchronization raster.

12. The method of claim 11, wherein:
the synchronization raster is a legacy synchronization raster.

13. The method of claim 11, wherein:
the synchronization raster is different from a legacy synchronization raster.

14. The method of claim 11, wherein:
the synchronization raster is selected from a plurality of synchronization rasters based at least in part of a configuration of the downlink signal.

15. The method of claim 11, wherein configuring the downlink signal comprises:
configuring the downlink signal to indicate at least one other synchronization raster, wherein the at least one other synchronization raster is adapted to carry at least one other downlink signal configured to assist the at least one UE to detect the synchronization signal transmitted from the at least one cell in the active state.

16. The method of claim 1, wherein transmitting the downlink signal comprises:
transmitting the downlink signal with a default periodicity.

17. The method of claim 1, wherein transmitting the downlink signal comprises:
transmitting the downlink signal with a pre-configured periodicity, wherein the pre-configured periodicity is different from a default periodicity.

18. The method of claim 1, wherein transmitting the downlink signal comprises:
transmitting the downlink signal with a configurable periodicity.

19. The method of claim 1, wherein transmitting the downlink signal comprises:
transmitting the downlink signal in a beam-sweeping manner.

20. The method of claim 1, wherein the downlink signal comprises at most two symbols, and/or wherein the downlink signal is configured to indicate that at least one frequency channel is within a pre-configured range on a frequency raster or to indicate that the at least one frequency channel is not within a pre-configured range on the frequency raster and the pre-configured range exceeds a threshold.

21. The method of claim 1, wherein the downlink signal comprises:
a reference signal in a preamble; and
additional assistance information.

22. The method of claim 21, wherein:
the additional assistance information comprises one or more of:
periodicity information, cell identification information, synchronization raster offset information.

23. The method of claim 1, further comprising:
receiving, from a network entity, information for configuring the downlink signal.

24. The method of claim 1, further comprising:
determining that the at least one UE has established a connection with the at least one cell in the active state; and
transmitting additional assistance information to the at least one UE based at least in part on the determining,
wherein the additional assistance information is configured to assist the at least one UE with one or more of: a subsequent access procedure, a cell re-selection procedure, and a radio resource management (RRM) measurements procedure.

25. The method of claim 1, further comprising:
receiving a notification that the at least one UE has received the downlink signal.

26. The method of claim 1, wherein configuring the downlink signal comprises
configuring the downlink signal to assist the at least one UE to detect the synchronization signal transmitted from the at least one cell in the active state on a synchronization raster; and wherein transmitting the downlink signal comprises
transmitting the downlink signal during the semi-active state on a frequency raster which is different from said synchronization raster.

27. A method for wireless communication by a user equipment (UE), comprising:
receiving a downlink signal from a cell in a semi-active state corresponding to an energy-saving mode of operation of the cell;
detecting, based at least in part on the downlink signal, a synchronization signal transmitted from at least one cell in an active state; and
establishing a connection with the at least one cell in the active state based at least in part on the synchronization signal.

28. The method of claim 27, further comprising:
transmitting an uplink request for additional assistance information to the cell in the semi-active state; and
receiving an additional downlink signal comprising additional assistance information; wherein detecting the synchronization signal transmitted from the at least one cell in the active state is further based at least in part on the additional downlink signal.

29. An apparatus for wireless communication by a cell, comprising:
a processor;
memory coupled with the processor; and
instructions stored in the memory and executable by the processor to cause the apparatus to:
enter a semi-active state corresponding to an energy-saving mode of operation of the cell;
configure a downlink signal to assist at least one user equipment (UE) to detect a synchronization signal transmitted from at least one cell in an active state; and
transmit the downlink signal during the semi-active state.

30. A method for wireless communication by at least one first cell and at least one second cell, comprising:
entering, at the at least one first cell and at the at least one second cell, a semi-active state corresponding to an energy-saving mode of operation of the at least one first cell and the at least one second cell;
configuring, at the at least one first cell at least one first downlink signal, and at the at least one second cell at least one second downlink signal, to assist at least one user equipment (UE) to detect on at least one frequency channel a synchronization signal transmitted from at least one cell in an active state;
wherein the at least one first downlink signal is configured to indicate that the at least one frequency channel is within a pre-configured range on a frequency raster, and wherein the at least one second downlink signal is configured to indicate that the at least one frequency channel is not within a pre-configured range on a frequency raster; and
transmitting the at least one first downlink signal from the at least first cell, and the at least one second downlink signal from the at least one second cell, during the semi-active state corresponding to an energy-saving mode of operation of the at least one first cell and the at least one second cell.
